(19) United States
(12) Patent Application Publication
(10) Pub. No.: US 2026/0050366 A1
(43) Pub. Date: Feb. 19, 2026

(54) VIRTUAL TWIN OF A SMART DWELLING

(71) Applicant: SmartThings, Inc., Minneapolis, MN (US)

(72) Inventors: Mark Dennis Benson, Maple Grove, MN (US); Mark Allen Tekippe, Eagan, MN (US)

(73) Assignee: SmartThings, Inc., Minneapolis, MN (US)

(21) Appl. No.: 19/301,620

(22) Filed: Aug. 15, 2025

Related U.S. Application Data
(60) Provisional application No. 63/684,180, filed on Aug. 16, 2024.

(51) Int. Cl. G06F 3/0484; G05B 17/02

(52) U.S. Cl. CPC G06F 3/0484; G05B 17/02

(57) ABSTRACT

A virtual twin of a smart dwelling is provided. In an aspect, the virtual twin maintains information about a smart dwelling and the devices associated with the smart dwelling. In examples, a user may use the virtual twin to control smart devices in the smart dwelling and change settings of the smart devices. In other examples, the virtual twin may be used to apply user preferences from the smart devices in the smart dwelling to smart devices in a temporary dwelling, such as a hotel room or a rental property. In further examples, the virtual twin may be used to assign permissions to guests to control aspects of the smart dwelling and the virtual twin. In some examples, the virtual twin may generate recommendations for a user related to the smart dwelling.

### CROSS-REFERENCE TO RELATED APPLICATION(S)

This application claims the benefit of and priority to U.S. Application No. 63/684,180, filed on Aug. 16, 2024, titled VIRTUAL TWIN OF A SMART DWELLING, the disclosure of which is hereby incorporated by reference in its entirety.

### BACKGROUND

Smart devices are becoming more common within households and other dwellings. In many cases, multiple smart devices are present in and around a dwelling.

These smart devices may be permanently installed fixtures (e.g., appliances, such as washers, dryers, HVAC systems, and lighting fixtures) or removable devices (e.g., televisions, sensors, and vacuum cleaners). The smart devices in a dwelling may have different systems for managing the devices, forcing users to use a plurality of systems to manage a plurality of devices. Similarly, information associated with the smart devices may be maintained in separate systems. As the number of smart devices in a dwelling increases, it becomes increasingly challenging to manage each of the smart devices across the plurality of systems. Additionally, it becomes increasingly challenging to share temporary access or transfer ownership of the smart devices and systems to another user, such as a guest, technician, service provider, or a new homeowner.

In further examples, when traveling or staying in a different dwelling, such as a hotel room or a rental property, users may wish to carry over their set preferences from their home to the temporary dwelling. This may require the user to manually adjust the settings of each device in the temporary dwelling until the user's preferences are met.

### SUMMARY

In general terms, this disclosure is directed to a virtual twin of a smart dwelling. In some embodiments, and by non-limiting example, the virtual twin maintains information about a smart dwelling and the devices associated with the smart dwelling. In examples, a user may use the virtual twin to manage smart devices in the smart dwelling, assign permissions to guest users, apply user preferences set at the smart dwelling to a temporary dwelling, and receive recommendations related to the smart dwelling.

In an aspect, a method for managing access to smart devices is provided. A virtual twin of a dwelling is generated. The virtual twin of the dwelling includes control of one or more smart devices in the dwelling. One or more permissions for a guest are designated. The one or more permissions include a level of control of the one or more smart devices in the dwelling. At least partial control of the virtual twin of the dwelling is granted to the guest. The at least partial control of the virtual twin of the dwelling is based on the designated one or more permissions.

In another aspect, a method for managing a setting of a smart device is provided. A virtual twin of a first dwelling is generated. The virtual twin of the first dwelling includes control of one or more smart devices in the first dwelling. One or more user preferences are associated with the virtual twin of the first dwelling. The one or more user preferences include settings for at least one of the one or more smart devices. At least partial control of a smart device in a second dwelling is received. A setting of the smart device in the second dwelling is automatically modified based on the user preferences associated with the virtual twin of the first dwelling.

In another aspect a method for generating a recommendation for a smart dwelling is provided. A virtual twin of a smart dwelling is generated. The virtual twin includes data associated with the smart dwelling. The data in the virtual model associated with the smart dwelling is analyzed. A recommendation associated with the smart dwelling is generated based on the analysis.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example environment in which a virtual twin of a smart dwelling may operate.

FIG. 2 illustrates an example embodiment of a virtual twin.

FIG. 3 illustrates an example device list user interface in a virtual twin application.

FIG. 4 illustrates an example settings user interface in a virtual twin application.

FIG. 5 illustrates an example floorplan user interface in a virtual twin application.

FIG. 6 illustrates an example service provider user interface in a virtual twin application.

FIG. 7 illustrates an example account credentials user interface in a virtual twin application.

FIG. 8 illustrates an example hierarchy of user permissions in a virtual twin.

FIG. 9 illustrates an example user permissions user interface in a virtual twin application.

FIG. 10 illustrates an example permission assignment user interface in a virtual twin application.

FIG. 11 illustrates an example notification associated with an assignment of permissions to a user.

FIG. 12 illustrates an example limited control user interface in a virtual twin application.

FIG. 13 illustrates an example maintenance history user interface in a virtual twin application.

FIG. 14 illustrates another example embodiment of an environment in which a virtual twin of a smart dwelling may operate.

FIG. 15 illustrates an example application integration user interface in a virtual twin application.

FIG. 16 illustrates a further example embodiment of an environment in which a virtual twin of a smart dwelling may operate.

FIG. 17 illustrates an example guest home user interface in a virtual twin application.

FIG. 18 illustrates an example control user interface in a virtual twin application.

FIG. 19 illustrates an example environment in which a virtual twin may generate recommendations.

FIG. 20 illustrates an example recommendation user interface in a virtual twin application.

FIG. 21 illustrates an example notification associated with a recommendation from a virtual twin.

FIG. 22 illustrates an example transfer of ownership of a virtual twin.

FIG. 23 illustrates a flowchart of an example method for managing access to smart devices in a smart dwelling.

FIG. 24 illustrates a flowchart of an example method for managing settings of smart devices.

FIG. 25 illustrates a flowchart of an example method for generating recommendations for a smart dwelling with a virtual twin.

FIG. 26 illustrates an example embodiment of a computing device.

FIG. 27 illustrates an example embodiment of a smart device.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As used herein, the term “including” should be read to mean “including, without limitation,” “including but not limited to,” or the like. The term “substantially” as used herein is a broad term and is to be given its ordinary and customary meaning to a person of ordinary skill in the art (and is not to be limited to a special or customized meaning), and furthermore refers without limitation to being largely but not necessarily wholly that which is specified.

As used herein, the term “smart device” includes electronic devices that can connect to one or more other devices over a network. The term “smart dwelling” as used herein includes dwellings—such as houses, apartments, townhomes, hotel rooms, rental properties, and other similar living quarters—that include one or more smart devices. “Smart dwellings” as described herein may additionally include smart devices associated with the dwelling that are not physically located within the dwelling. For example, a smart doorbell may be located on the outside of a smart dwelling and smart sensors may be located on a fence surrounding the smart dwelling. Additionally, other property associated with the dwelling may be included with the smart dwelling, such as a car and any smart devices associated with the car.

As briefly described above, embodiments of the present disclosure are directed to a virtual twin of a smart dwelling. While examples described herein may refer to a specific type of dwelling, such as a smart home, the systems and methods described herein are applicable to any kind of dwelling, whether permanent or temporary, including homes, apartments, hotel rooms, and rental properties.

In example aspects, a virtual twin of a smart dwelling is a digital model that is associated with and represents a dwelling. In embodiments, the virtual twin includes information associated with the smart dwelling and the devices in the smart dwelling. For example, the virtual twin may include dwelling information, configuration information, and user preferences, such as floorplans, device information and settings, and account credentials associated with the smart dwelling.

In an example, a user may use the virtual twin to manage aspects of the smart dwelling. For example, the user may control smart devices in the smart dwelling with the virtual twin.

In other example aspects, elements of the virtual twin can be applied to temporary dwellings when the owner is away from the smart dwelling. For example, when the owner rents a property for a limited period of time (e.g., the owner rents a condo or hotel room while on vacation), the owner can apply settings for smart devices in the smart dwelling to corresponding smart devices of the rental property. Similarly, other user preferences maintained in the virtual twin may be applied to the rental property.

In further example aspects, permissions may be assigned within the virtual twin that allow other users to manage the virtual twin and devices within the smart dwelling. For example, a guest user may be assigned permissions to control a smart device without being able to change the settings of the smart device. In another example, a service provider or repair person may be granted permissions to lock and unlock a smart lock during a designated time period so that the service provider or repair person can access the smart dwelling to perform repairs on appliances within the smart dwelling.

In other example aspects, the virtual model may provide recommendations to the user. For example, data in the virtual model may be analyzed to determine personalized recommendations for the user related to the smart dwelling.

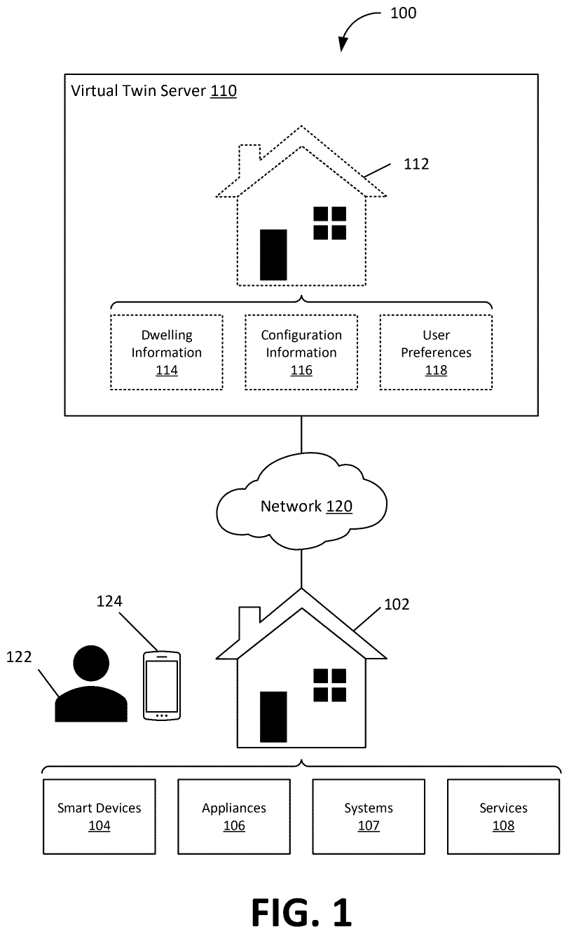

Turning now to FIG. 1, an example environment 100 for use of a virtual twin of a smart dwelling is shown. In the illustrated embodiment, the environment 100 includes a smart dwelling 102 and a virtual twin server 110.

The smart dwelling 102 includes smart devices 104, appliances 106, and other systems 107. Examples of appliances 106 include refrigerators, ovens, washing machines, and the like. Examples of systems 107 include electrical systems, plumbing systems, sprinkler systems, and the like. In some embodiments, an appliance 106 or a system 107 may also be a smart device—for example, a refrigerator may be a smart refrigerator (i.e., the refrigerator may be connected to a network of electronic devices). Similarly, a component of an appliance 106 or a system 107 may be a smart device-for example, a circuit breaker or an electrical panel in an electrical system may be a smart device. In the illustrated embodiment, services 108 are also provided to the smart dwelling 102, such as internet services and streaming services.

The virtual twin server 110 maintains a virtual twin 112 of the smart dwelling 102. In the illustrated embodiment, the virtual twin 112 includes dwelling information 114, configuration information 116, and user preferences 118 related to the smart dwelling 102 and the associated smart devices 104, appliances 106, and services 108. As described further herein, the virtual twin 112 provides a centralized platform for control and management of the smart devices 104, appliances 106, and services 108 associated with the smart dwelling 102. For example, a user 122 may use a mobile device 124 to connect to the virtual twin 112 to manage the smart devices 104 in the smart dwelling 102. In alternative examples, the user 122 may use a different computing device to connect to the virtual twin 112.

Further, the virtual twin 112 allows a user 122 to easily manage access for guests or other users to the smart devices 104, appliances 106, and services 108 associated with the smart dwelling 102. In an example, the user 122 may provide guest permissions to a repair person, allowing the repair person to access the smart dwelling and temporarily access smart devices 104, appliances 106, and services 108 necessary to complete a repair job.

While the virtual twin server 110 is illustrated as a single server in the illustrated embodiment, in alternative embodiments, the virtual twin server 110 includes a plurality of connected servers. For example, the virtual twin server 110 may include a distributed server network. Additionally, in some embodiments, the virtual twin server 110 may include one or more cloud servers or one or more edge servers, or a combination cloud and edge servers.

In the illustrated embodiment, the smart dwelling 102 connects to the virtual twin server 110 over a network 120, such as the Internet. In an example, a hub within the smart dwelling 102 connects to the virtual twin server 110 over the network 120. In an example, the mobile device 124 of the user 122 may act as a hub for the smart dwelling 102. In this example, the mobile device 124 may connect to the virtual twin server 110 and the smart devices 104 in the smart dwelling 102 to act as an intermediary between the smart devices 104 and the virtual twin 112. In another example, a smart device 104 may similarly act as a hub for the smart dwelling 102.

While not shown for ease of illustration, the environment 100 may include multiple networks. For example, a local network within the smart dwelling 102 may connect the smart devices 104 and appliances 106, and the network 120 may connect the smart dwelling 102 to the virtual twin server 110.

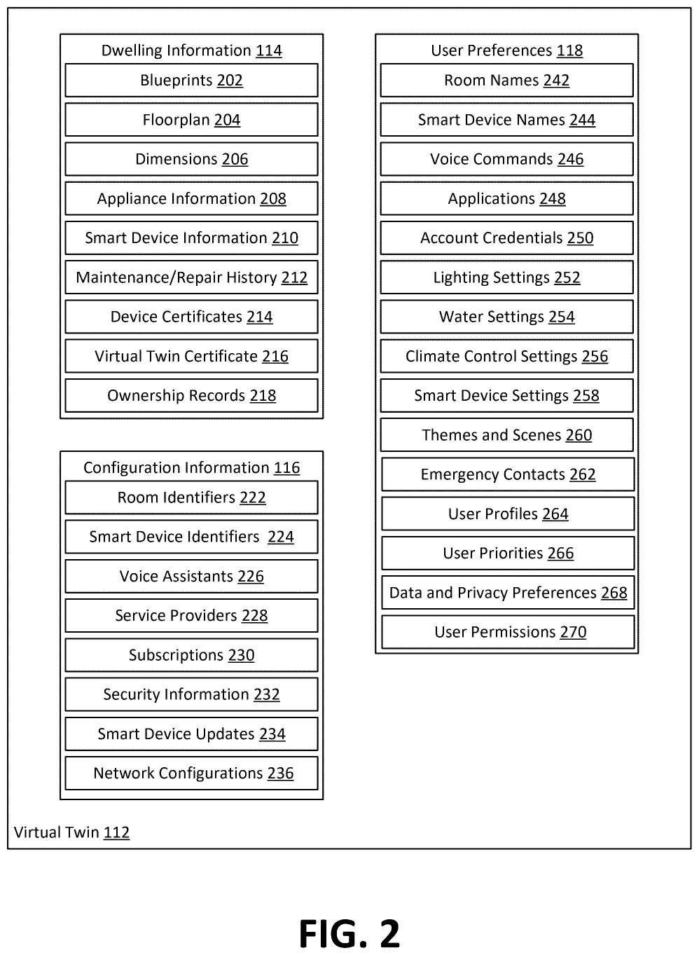

FIG. 2 illustrates an example embodiment of a virtual twin 112. As described briefly above, the virtual twin 112 includes dwelling information 114, configuration information 116, and user preferences 118 associated with a smart dwelling and associated smart devices, appliances, and services. While the embodiment shown in FIG. 2 includes examples of the data included in the virtual twin 112, in alternative embodiments, additional or alternative data may be included in the virtual twin 112. In embodiments, the virtual twin 112 may include any data associated with a smart dwelling. Similarly, in some embodiments, the virtual twin 112 includes a subset of the information illustrated in FIG. 2. For example, in an embodiment, the virtual twin 112 may include blueprints 202 but not floorplans 204.

The dwelling information 114 includes data associated with substantially static elements of a smart dwelling—i.e., elements of the smart dwelling that are not frequently changed. Examples of dwelling information include blueprints 202, floorplans 204, and dimensions 206 for the smart dwelling, appliance information 208, smart device information 210, maintenance and repair histories 212, device certificates 214, and a virtual twin certificate 216. In some embodiments, the dwelling information 114 may include any digital documentation associated with the smart dwelling, including inspection records, appraisals, titles, liens, and tax assessments.

Blueprints 202, floorplans 204, and dimensions 206 describe a physical layout of the smart dwelling associated with the virtual twin 112. In an example, the blueprints 202, floorplans 204, and dimensions 206 are added to the virtual twin 112 by user input. For example, a user (e.g., an owner of the smart dwelling, a builder of the smart dwelling, or a virtual twin technician) may upload documents describing the blueprints 202, floorplans 204, and dimensions 206 to the virtual twin server 110 for inclusion in the virtual twin 112. Documents imported from an external data source (e.g., a real estate database or a home builder database) may similarly be used for the blueprints 202, floorplans 204, and dimensions 206. In another example, the blueprints 202, floorplans 204, and dimensions 206 are determined based on images of the smart dwelling, such as two-dimensional images or three-dimensional scans of the smart dwelling. In further examples, a user may manually draw the floorplan 204 of the smart dwelling.

Appliance information 208 and smart device information 210 describe information related to appliances and smart devices, respectively, in the smart dwelling. Examples of appliance information 208 and smart device information 210 include model names, model numbers, serial numbers, information describing components of the appliance/smart device (e.g., appliance filter specifications and smart device battery types and statuses), network addresses (e.g., IP addresses), manufacturing dates, installation dates, registration dates (i.e., dates on which the appliances/smart devices were registered with the virtual twin 112), onboarding information (e.g., a QR code or other code used to onboard a smart device), data collected by the associated appliances and smart devices, device states, device histories, and warranty information. In an example, the appliance information 208 and the smart device information 210 is added to the virtual twin 112 manually by a user. In another example, the virtual twin 112 may communicate with appliances/smart devices to retrieve appliance information 208 and smart device information 210 automatically from the appliances/smart devices.

Maintenance and repair histories 212 describe maintenance and repairs performed on the smart devices and appliances in the smart dwelling. For example, the maintenance and repair histories 212 may include a maintenance log describing types of maintenance performed, dates of maintenance, and repair person information. In embodiments, the maintenance and repair histories 212 may be added to the virtual twin 112 by a user. For example, as described further herein, an owner of the smart dwelling may give a repair person access to add maintenance logs to the maintenance and repair histories 212.

In embodiments, the maintenance and repair histories 212 may be used to generate automatic maintenance reminders. For example, a filter for an HVAC system may need to be replaced every six months. In this example, the virtual twin 112 may determine that the maintenance log for the HVAC system has not been updated in the past six months and generate a reminder for the user to replace the filter. In another example, the reminder may be generated before the maintenance is due so that the user has time to schedule the maintenance (e.g., the virtual twin may generate a reminder to change the HVAC filter if it has not been changed in the past five months so that the user can schedule maintenance before the six month date).

Device certificates 214 include certificates and similar authentication and cryptographic documents for the smart devices of the smart dwelling. In examples, the device certificates 214 include electronic documents that can be used to authenticate the associated smart devices'identities and the identity of the owner of the smart devices. In some embodiments, the device certificates 214 include a copy of the authentication documents from the smart devices. In embodiments, the device certificates 214 include metadata associated with the authentication documents from the smart devices. The virtual twin 112 may communicate with the smart devices to retrieve the authentication documents and metadata automatically from the smart devices.

Virtual twin certificates 216 includes similar authentication documents to the device certificates 214. In an example, the virtual twin certificate 216 includes an authentication document to authenticate the virtual twin 112 and an owner of the virtual twin 112. In another example, the virtual twin certificates may additionally include a digital version of a title to the smart dwelling. In an embodiment, the virtual twin certificate 216 is created upon initialization of the virtual twin 112. In an example, an external certificate service creates the virtual twin certificate 216. In some embodiments, the virtual twin certificates 216 may be stored in or linked to a public ledger (e.g., a distributed blockchain) or another database. By storing/linking the virtual twin certificates 216 to a public ledger or another database, transfer of the virtual twin 112 to another owner may be facilitated-for example, when the smart dwelling is sold.

Ownership records 218 include information about past and current owners of the virtual twin 112. In some examples, the ownership records 218 include information about past and current owners of the smart dwelling. In embodiments, the ownership records 218 may be used to verify that the owner of the virtual twin 112 is a legitimate owner of the virtual twin 112. In an example, the ownership records 218 may be used in conjunction with the virtual twin certificate 216 to confirm ownership of the virtual twin 112. In an embodiment, the ownership records are maintained across a secure, public, distributed blockchain ledger. In such embodiments, the virtual twin 112 may include a reference to the ownership records in the distributed ledger.

The configuration information 116 includes data associated with a global configuration of the virtual twin 112 and the smart dwelling. In an example, the configuration information 116 is not specific to a user. In the illustrated embodiment, the configuration information 116 includes room identifiers 222, smart device identifiers 224, voice assistants 226, service providers 228, subscriptions 230, security information 232, smart device updates 234, and network configurations 236.

Room identifiers 222 include identifiers for rooms in the smart dwelling. In an example, the room identifiers 222 may be associated with the blueprints 202 and floorplan 204. In an embodiment, the room identifiers 222 are generated for rooms in the smart dwelling when blueprints 202 or a floorplan 204 are added to the virtual twin 112. In an example, a room identifier 222 for a room in the smart dwelling may be defined as “Room 1” or “Bedroom 1.” As described further herein, user preferences 118 may be set by a user to personalize a name for the room.

Smart device identifiers 224 include information to identify smart devices in the smart dwelling. In an example, the smart device identifications 224 include names for the smart devices and locations of the smart devices within the smart dwelling (e.g., what room the smart device is located in). For example, a smart device may have a name defined as “Television 1” and a location defined as “Room 1” in the smart device identifiers 224. In an embodiment, a user inputs the smart device identifiers 224 into the virtual twin 112. In another embodiment, some information included in the smart device identifiers 224 may be automatically retrieved from a smart device when the smart device is registered with the virtual twin 112. For example, a type of smart device may be automatically retrieved from the smart device, and the smart device identifier 224 may be generated based on the retrieved device type. As described further herein, user preferences 118 may be set by a user to personalize a name for a smart device.

Voice assistants 226 include registered software for processing voice commands of a user, such as voice assistants or AI large-language models (LLMs). Examples of voice assistants 226 include Bixby® from Samsung® and other popular voice assistants. A user may register selected voice assistants 226 with the virtual twin 112 and configure the virtual twin 112 to use one or more voice assistants 226.

Service providers 228 include identifiers of service providers that provide services to the smart dwelling. Contact information of service providers may additionally be included in the service providers 228. Examples of service providers 228 include trash services, electricity services, water services, gas services, internet services, repair services, and television services (e.g., cable or satellite services). A user may add service providers 228 to the virtual twin 112. In another example, service providers 228 may automatically be added to the virtual twin 112 based on the maintenance and repair histories 212. For example, if a repair person from a service provider adds a maintenance log, the virtual twin may automatically register the service provider with the service providers 228 in the virtual twin 112. By maintaining a registry of service providers 228, users (such as a current owner of the smart dwelling, a further owner of the smart dwelling, or a designated caretaker of an individual living in the smart dwelling) can easily understand which service providers have been used or are preferred.

Subscriptions 230 include information associated with subscriptions to services for the smart dwelling. In an example, the subscriptions 230 may be associated with the service providers 228 described above. For example, the subscriptions 230 may include subscriptions for trash services, electricity services, water services, gas services, internet services, repair services, and television services. In an embodiment, the subscriptions 230 may include start and end dates of the subscriptions, prices of the subscriptions, payment information associated with the subscriptions, and renewal options for the subscriptions.

Security information 232 includes information associated with security devices in the smart dwelling. In an example, the security information 232 includes passcodes for smart locks and codes to arm and disarm an alarm system.

Smart device updates 234 include software and firmware updates to smart devices in the smart dwelling. In an embodiment, the virtual twin 112 may receive smart device updates 234 from a third-party server. For example, the virtual twin server 110 may connect to a server of a manufacturer of a smart device and receive updates for the smart device from the manufacturer server. The virtual twin 112 may then push the update to the corresponding smart device.

Network configurations 236 include information associated with network infrastructure in the smart dwelling. For example, the network configurations 236 may include information associated with a wireless network (e.g., a Wi-Fi network) within the smart dwelling. In an example, the network configurations 236 may be retrieved from a router, modem, or other smart device within the smart dwelling. In another example, a user may input information for a network configuration 236.

The user preferences 118 include data associated with personalization of the virtual twin 112 and the smart dwelling by the user. In the illustrated example, the user preferences 118 include room names 242, smart device names 244, voice commands 246, applications 248, account credentials 250, lighting settings 252, water settings 254, climate control settings 256, device settings 258, themes and scenes 260, emergency contacts 262, user profiles 264, user priorities 266, data and privacy preferences 268, and user permissions 270.

Room names 242 include personalized names for rooms in the smart dwelling. As described above with the configuration information 116, rooms may be assigned room identifiers 222 such as “Room 1” when the floorplan 204 is registered with the virtual twin 112. The room names 242 may be associated with the floorplan 204 and the room identifiers 222 and allow a user to personalize the names of the rooms. For example, if “Room 1” (as identified in the room identifiers 222) is a bedroom belonging to Janet, a user may set a name for the room to be “Janet's Bedroom. ”

Smart device names 244 similarly include personalized names for smart devices in the smart dwelling. As described above with the configuration information 116, smart devices may be assigned smart device identifiers 224 such as “Television 1” when the smart devices are registered with the virtual twin 112. The smart device names 244 may be associated with the smart device identifiers 224 and allow a user to personalize the names of the smart devices. For example, if “Television 1” (as identified in the smart device identifiers 224) is a television in a living room, a user may set a name for the television to be “Living Room Television.”

Voice commands 246 include commands registered by the user for controlling aspects of the virtual twin 112 or smart dwelling by speaking. For example, the voice commands 246 may include commands to control smart devices in the smart dwelling. In an example, a user may register a voice command 246 so that when the user says “turn on the living room lights,” the lights in the living room of the smart dwelling turn on. The voice commands 246 may be set by a user of the virtual twin 112. In an example, the user registers voice commands 246 with smart devices, and the virtual twin 112 pulls the voice commands 246 from the smart devices. In an alternative example, the user registers the voice commands 246 with the virtual twin 112, and the virtual twin 112 pushes the voice commands 246 to the appropriate smart devices. In embodiments, the voice commands 246 may be associated with specific voice assistants 226.

Applications 248 include software applications and other programs that can be executed by the virtual twin 112 or by smart devices, appliances, or other systems in the smart dwelling. Examples of applications 248 include streaming applications, games, and applications for controlling accounts of a user. In embodiments, applications 248 are registered with the virtual twin 112 by a user. For example, users may download applications from an application store. The applications 248 may additionally or alternatively include artificial intelligence or machine learning models that operate on the virtual twin 112 or associated smart devices, appliances, or other systems. Examples of artificial intelligence and machine learning models include voice recognition or camera-based facial recognition models operating on camera-feeds in the smart dwelling, preventive maintenance models that detect faults or issues with smart devices, appliances and systems in the smart dwelling and notify users (e.g., an owner of the smart dwelling or a service provider) if an issue is detected, and models that analyze smart dwelling data to detect if someone is present in the home, how many people are in the home, or who is in the home.

Applications 248 may additionally or alternatively include third-party applications that can control the virtual twin. As described further herein, a third-party server may connect to the virtual twin 112 to control aspects of the virtual twin 112 or the smart dwelling when conditions are satisfied. For example, the applications 248 may include a ride-sharing application that is given permission to control lights in the smart dwelling when a driver arrives at the smart dwelling.

Account credentials 250 include user credentials for accessing accounts associated with the virtual twin 112. In examples, the account credentials 250 include credentials to access applications 248 and accounts associated with service providers 228 or subscriptions 230. In an embodiment, a user registers the account credentials 250 with the virtual twin 112.

Lighting settings 252 include settings for controlling lights within the smart dwelling. For example, lighting settings 252 may define an illumination intensity and color for lighting within a room of the smart dwelling. In another example, lighting settings 252 may include defined time ranges during which lights are turned on within the smart dwelling. In embodiments, a user sets the lighting settings 252 within the virtual twin 112. In some embodiments, the user sets lighting settings 252 with smart devices, and the virtual twin 112 pulls the lighting settings 252 from the smart devices.

Water settings 254 include settings for controlling water within the smart dwelling. For example, water settings 254 may define a temperature and volume of water to be dispensed by a sink or a shower within the smart dwelling. In embodiments, the water settings 254 may include set times at which water is dispensed. For example, the water settings 254 may define that eight ounces of water are dispensed by a kitchen faucet each morning at 6:15 AM. In an embodiment, a user sets the water settings 254 within the virtual twin 112. In some embodiments, the user sets water settings 254 with smart devices, and the virtual twin 112 pulls the water settings 254 from the smart devices.

Climate control settings 256 include settings for controlling the climate within the smart dwelling. For example, climate control settings 256 may control temperature and ventilation within the smart dwelling. In embodiments, the climate control settings 256 define time ranges during which different temperatures are set. For example, during the day, a temperature for the smart dwelling may be set at 71° F., and overnight, the temperature for the smart dwelling may be set at 69° F. In an embodiment, a user sets the climate control settings 256 within the virtual twin 112. In some embodiments, the user sets climate control settings 256 with smart devices, and the virtual twin 112 pulls the climate control settings 256 from the smart devices.

Smart device settings 258 include settings for smart devices in the smart dwelling. The smart device settings 258 define how the smart devices operate. In some embodiments, the smart device settings 258 may include lighting settings 252, water settings 254, and climate control settings 256. In an example, a user sets the smart device settings 258 with the corresponding devices, and the virtual twin 112 pulls the smart device settings from the smart devices. In other embodiments, the user sets the smart device settings 258 with the virtual twin 112, and the virtual twin 112 pushes the smart device settings 258 to the appropriate devices.

Themes and scenes 260 include defined styles and appearances for the virtual twin 112 and the smart dwelling. In an embodiment, the themes and scenes 260 may define colors and other aesthetic attributes of the virtual twin 112. For example, the themes and scenes 260 may describe appearances of a user interface associated with the virtual twin 112. In another example, the themes and scenes 260 include device settings 258 for smart devices in the smart dwelling. In an embodiment, a user defines the themes and scenes 260 in the virtual twin 112. In some embodiments, the user may download themes and scenes 260 from an online repository of themes and scenes. For example, the online repository of themes and scenes may include themes and scenes 260 created by other users.

Emergency contacts 262 include contact information for individuals who are contacted in case of an emergency (e.g., a medical emergency). In an example, the emergency contacts 262 include a phone number of a designated emergency contact. In embodiments, a user enters the emergency contacts 262 in the virtual twin 112.

User profiles 264 include information about users of the virtual twin 112, such as an owner of the smart dwelling. In an example, a user profile 264 includes biographical data about a user, such as a name, age, and gender. In another example, the user profile 264 may include interests and hobbies of the user. Information in the user profiles 264 may be entered by a user. As described further herein, the user profiles 264 may be used to personalize the virtual twin 112 for the users and generate recommendations for the users.

User priorities 266 include information about priorities of the users of the virtual twin 112. Examples of priorities that may be included in the user priorities 266 include energy savings, cost efficiency, comfort, convenience, security, and privacy. In an embodiment, a user may define the user priorities 266. In an alternative embodiment, user priorities 266 may additionally or alternatively be determined automatically by the virtual twin 112 based on other data in the virtual twin 112, such as smart device settings 258.

In some examples, the virtual twin 112 may automatically modify lighting settings 252, water settings 254, climate control settings 256, and smart device settings 258 based on user priorities 266. Additionally, as described further herein, the user priorities 266 may be used to personalize the virtual twin 112 and generate recommendations.

Data and privacy settings 268 include settings defining how data is handled in the virtual twin 112. For example, the data and privacy settings 268 may define what information is stored in the virtual twin 112, how long the data is stored in the virtual twin 112, how the data in the virtual twin 112 can be used, how PII and private information is handled in the virtual twin 112, and who can use the data in the virtual twin 112. In an example, as described further herein, in some embodiments, recommendations may be generated for a virtual twin 112 based on a similar virtual twin. The data and privacy settings 268 may allow a user to determine whether data in the virtual twin 112 can be used to provide recommendations for other virtual twins. In an embodiment, a user may set the data and privacy settings 268.

User permissions 270 include permissions for users to manage the virtual twin 112 and smart devices within the smart dwelling. As described further herein, the user permissions 270 may define what smart devices a user has access to and how the user can use the smart devices. For example, a first user may have permissions allowing the first user to access a Wi-Fi network in the smart dwelling. The user permissions 270 may be set by a user of the virtual twin 112, such as an owner of the smart dwelling.

While the illustrated embodiment shows the data included in the virtual twin 112 distributed into three categories (i.e., dwelling information 114, configuration information 116, and user preferences 118), in alternative embodiments, the data included in the virtual twin 112 may be organized in different configurations. For example, all of the data associated with a smart device (e.g., smart device information 210, device certificates 214, smart device identification 224, smart device updates 232, and smart device settings 258) are stored together.

Similarly, while the illustrated embodiment presents lighting settings 252, water settings 254, climate control settings 256, and smart device settings 258 separately in the user preferences 118, in some embodiments, the smart device settings 258 may include the lighting settings 252, water settings 254, and climate control settings 256 that are relevant for the smart device. For example, the smart device settings 258 for a smart faucet may include water settings 254.

Further, the virtual twin 112 may track what data maintained therein is personal identifiable information (PII) or otherwise private information. As described further herein, ownership of the virtual twin 112 may transfer (e.g., from a seller of the smart dwelling to a buyer). During this transfer of ownership, to protect the privacy of the seller, some data may be cleared from the virtual twin 112, including PII and other private information. While much of the PII and private information may be included in the user preferences 118, the dwelling information 114 and the configuration information 116 may also include PII and private information. In an example, smart device information 210 may include data collected from smart devices that may be PII or private information. For example, a smart doorbell may include a camera that captures and stores images of individuals approaching the smart dwelling. The virtual twin 112 may track this data and similar private data so that when PII and private data needs to be cleared from the virtual twin 112, the virtual twin 112 can appropriately manage the data maintained therein.

Additionally, while the virtual twin 112 is shown as being maintained on a single virtual twin server 110 in the illustrated embodiment, in some embodiments, the data included in the virtual twin 112 is maintained across a distributed server network.

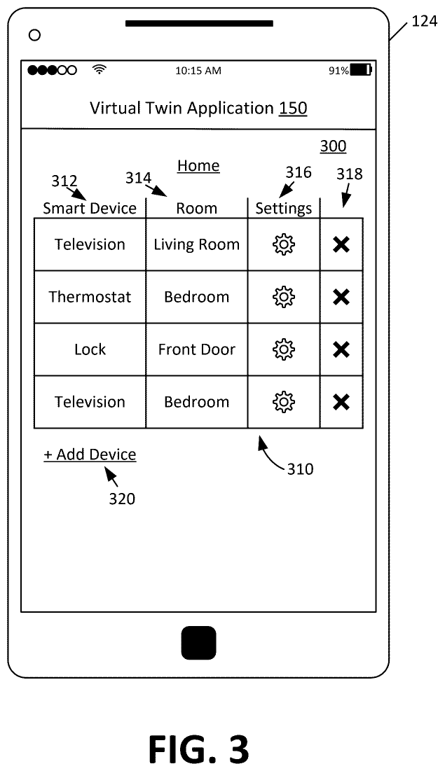

Turning now to FIGS. 3-7, example user interfaces for interacting with a virtual twin of a smart dwelling are shown. The user interfaces allow a user to add information to the virtual twin. Further, through the user interfaces, the user can interact with the virtual twin to manage aspects of the smart dwelling. In examples described herein, the user interfaces are shown in a virtual twin application 150 on a mobile device 124. In alternative embodiments, the user interfaces may be shown through other programs, such as a web interface, or on other computing devices. In an example, users may have a virtual twin account with the virtual twin application to view virtual twins for which they have access.

FIG. 3 illustrates an example device list user interface 300 presenting a list 310 of smart devices registered in a smart dwelling. In embodiments, the user interface 300 is shown to owners of the smart dwelling, and guests or other users who are granted limited permissions by the owner may be shown a different user interface, as described further herein.

In the illustrated embodiment, the list 310 of smart devices includes a device name 312, a location 314 of the smart device in the smart dwelling, a settings option 316, and a delete option 318. The user interface 300 also includes an option 320 to register an additional smart device. As described above, the device name 312 and location 314 may be entered by a user when the device is registered with the virtual twin and may be maintained as configuration information. The settings option 316 links to a settings user interface for the device. As described further herein, the settings user interface allows a user to modify settings for the associated device, such as changing the device name 312 or location 314. The delete option 318 allows a user to remove a smart device from the list 310 of registered smart devices.

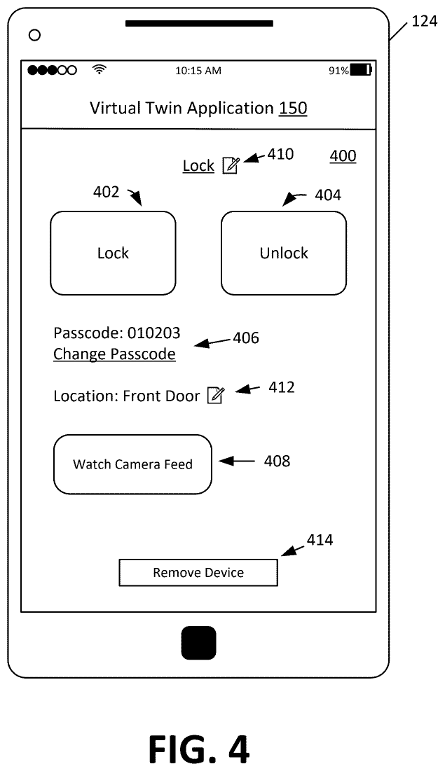

FIG. 4 illustrates an example of a settings user interface 400 for a smart device. In the illustrated example, the settings user interface 400 includes settings for a lock. In alternative embodiments, the settings user interface 400 may include different settings. For example, the settings user interface 400 may present settings for a different type of smart device; the settings presented in the settings user interface 400 may be different based on the smart device for which the settings user interface 400 is presented.

Additionally, the settings user interface 400 shown in the illustrated embodiment may be shown to an owner of the smart dwelling. In embodiments in which the settings user interface 400 is shown to guests or other users who are granted limited permissions by the owner, the settings user interface 400 may include different settings options.

In embodiments, the settings user interface 400 includes controls for the smart device (i.e., the smart lock). In examples, the settings set within the settings user interface 400 are saved as user preferences within the virtual twin. In the illustrated embodiment, the settings user interface 400 includes buttons 402, 404 that allow the user to lock and unlock the smart lock, respectively. The settings user interface 400 further includes an option 406 to change the passcode for the smart lock and watch a camera feed 408 from the smart lock through the virtual twin application 150. Additionally, the settings user interface 400 includes options 410, 412 to edit a name of the smart lock and edit a location of the smart lock within the smart dwelling. In the illustrated embodiment, the settings user interface 400 includes an option 414 to remove the smart lock from the virtual twin.

In alternative embodiments, the settings user interface 400 may include additional settings options. For example, the settings user interface 400 may include options to add or change any of voice commands, lighting settings, water settings, and climate control settings. The options presented in the settings user interface 400 may depend on the device for which the settings are being changed.

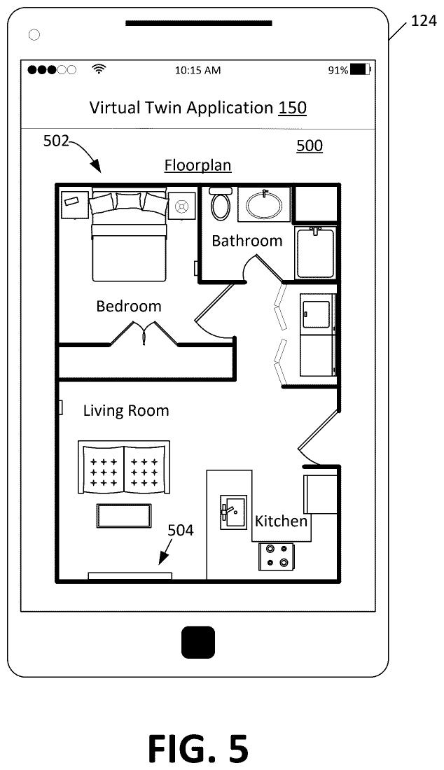

FIG. 5 illustrates a floorplan user interface 500 for presenting a floorplan of the smart dwelling. A similar user interface may be used to present blueprints of the smart dwelling. In the illustrated embodiment, the floorplan user interface 500 allows users to name rooms within the smart dwelling on the floorplan 502. As described above, room names may be maintained within the virtual twin as configuration information. Similarly, in some embodiments, the floorplan user interface 500 may include options for users to add smart devices to rooms shown in the floorplan 502. For example, in the illustrated embodiment, a user may indicate that a smart television 504 is located within the living room. Appliances and other devices may similarly be identified within the floorplan user interface 500.

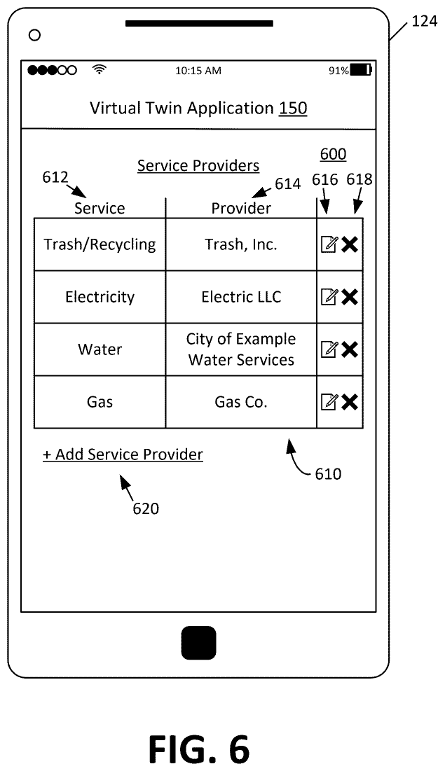

FIG. 6 illustrates an example service provider user interface 600. In the illustrated example, the service provider user interface 600 includes a list 610 of service providers. In embodiments, the list 610 of service providers includes services 614 being provided, names of the providers 612 of the services 614, and options 616, 618 to edit and delete registered service providers. The service provider user interface 600 further includes an option 620 to add a new service provider. As described above, the list 610 of service providers may be maintained in virtual twin as configuration information. In some embodiments, account credentials and other information associated with service providers may be linked to the list 610 of service providers.

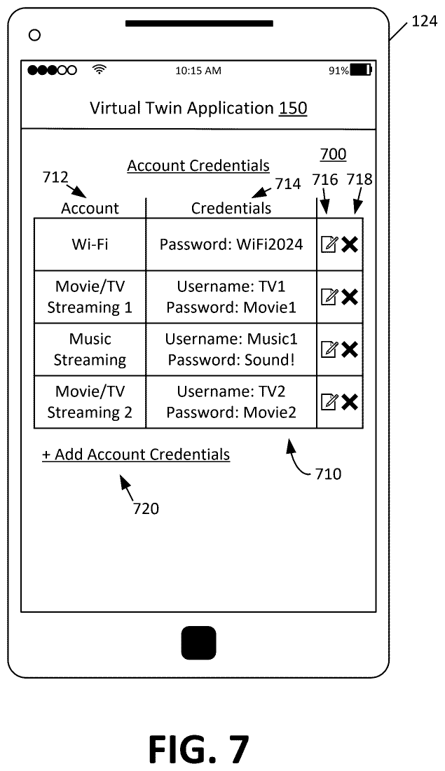

FIG. 7 illustrates an example account credentials user interface 700. In the illustrated embodiment, the account credentials user interface 700 includes a list 710 of account credentials associated with services, applications, and other accounts used within the smart dwelling. The list 710 of account credentials may include names 712 of the services and applications, account credentials 714 associated with the accounts, and options 716, 718 to edit and delete the account credentials. The account credentials user interface 700 additionally includes an option 720 to add account credentials. As described above, account credentials are maintained within the virtual twin as user preferences.

In an embodiment, the list 710 further includes an indication of which devices have access to the credentials 714 for an account. For example, a television may have access to a movie streaming service account (e.g., Movie/TV Streaming 1, as shown in FIG. 7) so that the user can watch movies on the television through the streaming service. Accordingly, the list 710 may indicate that the television has access to the credentials 714 for the movie streaming service account.

Additionally, in some embodiments, the account credentials user interface 700 may be protected to prevent unauthorized users from accessing the credentials to user accounts. In one example, the account credentials user interface 700 cannot be accessed without first authenticating the user (e.g., through a username/password or biometric authentication). In another example, the credentials 714 may be hidden until the user is authenticated.

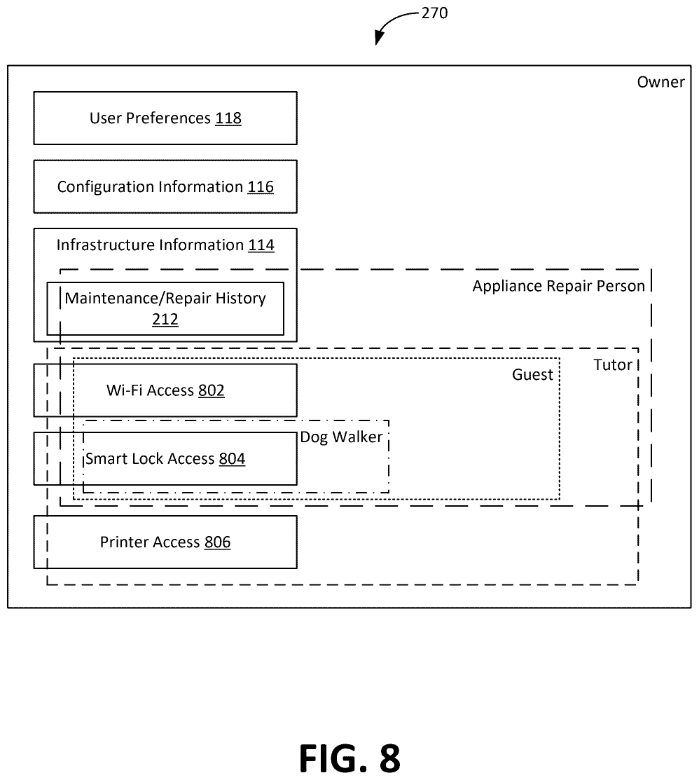

FIG. 8 illustrates an example hierarchy of user permissions 270. In the illustrated embodiment, the user permissions 270 include permissions for a plurality of users (i.e., an owner, an appliance repairman, a tutor, a guest, and a dog walker. Each of the users may have different permissions, granting the users access to different smart devices.

In the illustrated example, the owner has the highest level of permissions. As the owner of the smart device and virtual twin, the owner may have permissions to access all aspects of the virtual twin and manage all of the smart devices in the smart dwelling. Accordingly, the owner has access to the user preferences 118, the configuration information 116, and the dwelling information 114, as well as access to each of the smart devices (i.e., Wi-Fi access 802, smart lock access 804, and printer access 806). With access to the configuration information 116, the owner may set the permissions for other users.

The owner may set the permissions for the other users based on what the other users are doing at the smart dwelling. For example, the appliance repair person may be visiting the smart dwelling to repair an appliance. Accordingly, the owner may assign the appliance repair person permissions to edit the maintenance and repair history 212 of the appliance being repaired. The appliance repair person may further have Wi-Fi access 802 to do research for the repair and smart lock access 804 so the appliance repair person can access the smart dwelling even if the owner is not in the smart dwelling. Additionally, while not shown, some of the assigned permissions may be partial access or control of the smart device or the data. For example, the appliance repair person may be given permissions to view and append the maintenance and repair histories 212 for a specific appliance, but the appliance repair person may not be given permissions to edit existing logs in the maintenance and repair histories 212. In another example, the smart lock access 804 assigned to the appliance repair person may allow the appliance repair person to lock and unlock the smart lock but not change the passcode or grant access to additional users.

Other users may be assigned different permissions. For example, a tutor and a guest may be assigned Wi-Fi access 802 and smart lock access 804, like the appliance repairman, but do not have access to the maintenance and repair histories 212. The tutor may additionally have printer access 806, which the other users do not have. Further, a dog walker may have the most restrictive permissions, only having smart lock access 804.

Additionally, while not shown for ease of illustration, the permissions assigned to the users may be time-limited permissions. For example, the appliance repair person may be assigned smart-lock access only for a predetermined amount of time on a specific date on which the appliance repair person is expected to perform the repair of the appliance.

In examples, alerts may be generated if the permissions are used outside of the designated time period. For example, if the repair person is given a temporary passcode to unlock a smart-lock on the day the repair is scheduled, if the temporary passcode is used on another day, the smart-lock may not unlock, and an alert may be generated for the owner of the virtual twin.

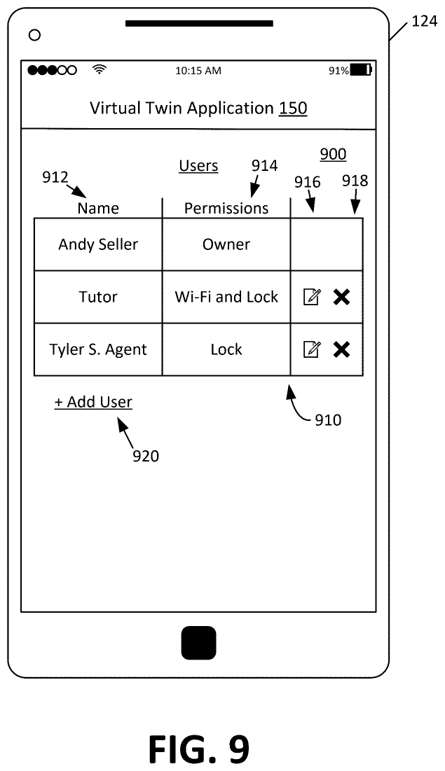

FIGS. 9-13 illustrate example user interfaces for granting permissions to a guest user and user interfaces for the guest user to manage the virtual twin based on the granted permissions.

FIG. 9 illustrates an example of a user permissions user interface 900. In the illustrated embodiment, the user permissions user interface 900 includes a list 910 of the users with permissions associated with the virtual twin. In an embodiment, the list 910 includes a name 912 of the user, permissions 914 associated with the user, and options 916, 918 to edit the permissions and delete the user, respectively. The user permissions user interface 900 may additionally include an option 920 to add a new user.

In the illustrated example, the permissions 914 shown for a user may be a summary of the permissions assigned to the user. For example, in some embodiments, a user may be assigned multiple permissions. Similarly, the permissions assigned to a user may have a time limit or defined times during which the permissions are active. Rather than show each permission assigned to the user and each time limit, the permissions 914 may instead include a brief summary of the assigned permissions. In alternative embodiments, the permissions 914 may include each permission assigned to a user and each time limit.

In the illustrated example, the options 916, 918 to edit the permissions of the owner and delete the owner are not available. In embodiments, the virtual dwelling needs an owner, so the owner cannot be edited or deleted. In examples, a transfer of ownership of the virtual twin, as described above, may be used to change the owner of the virtual twin.

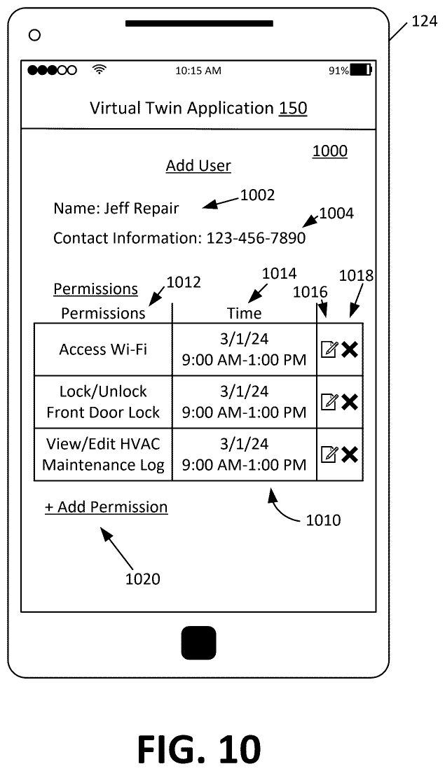

FIG. 10 illustrates an example permission assignment user interface 1000. In an example, the permission assignment user interface 1000 allows a user, such as an owner of the smart dwelling, to grant permissions to an additional user, such as a repairman. In some embodiments, the permission assignment user interface 1000 may only be accessible by specific users of the virtual twin, such as the owner of the smart dwelling.

In the illustrated embodiment, the permission assignment user interface 1000 includes fields 1002, 1004 to enter a name and contact information of the user to whom permissions are being granted. The permission assignment user interface 1000 additionally includes a list 1010 of permissions to be assigned to the user. In embodiments, the list 1010 of permissions includes permissions 1012, times 1014 at which the permissions are active for the user, and options 1016, 1018 to edit and delete the permissions 1012. In examples, the permissions 1012 provide the user access to a device or account in the smart dwelling. The times 1014 provide limits to the permissions 1012 so that the user can only use the permissions 1012 during the designated times 1014. For example, permissions 1012 assigned to a repair person may be limited to a time 1014 during which a repair is scheduled. The permission assignment user interface 1000 additionally includes an option 1020 to add an additional permission 1012 to the list 1010 of permissions.

In some embodiments, permissions 1012 that are associated with a time 1014 are automatically removed after a period set by the time 1014 expires. Similarly, in some embodiments, if each of the permissions 1012 are removed (e.g., time periods associated with each permission 1012 expire), the user may automatically be removed from the virtual twin.

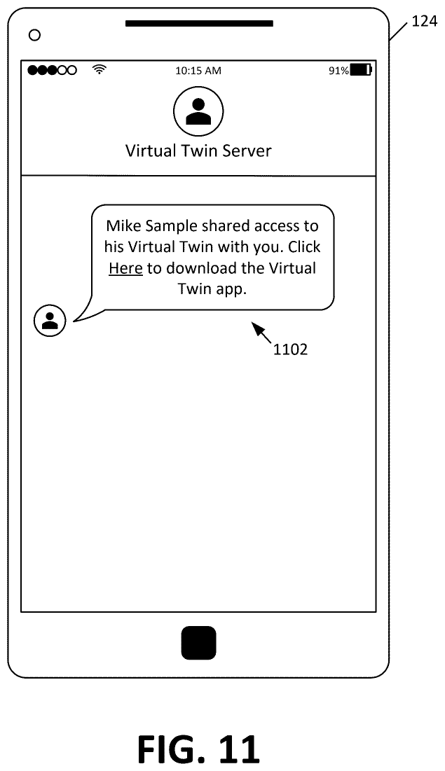

After a user is added to the virtual twin, a notification may be sent to the added user to inform the added user that they have been added to the virtual twin. FIG. 11 illustrates an example notification 1102 transmitted to an added user. In the illustrated embodiment, the notification 1102 is a text message (e.g., an SMS message). In alternative examples, the notification 1102 may be a different form of notification, such as an email message or a push notification.

The notification 1102 includes information for the added user to manage the smart dwelling and virtual twin based on the assigned permissions. In the illustrated example, the notification 1102 includes a link to download the virtual twin application, through which the added user may manage the smart dwelling and virtual twin in line with the assigned permissions. For example, the added user may create an account using the contact information with which the user received the notification 1102, and the account may automatically be given the assigned permissions. Similarly, in an embodiment, the notification 1102 includes a link to a virtual twin website through which the user can manage the smart dwelling and virtual twin in line with the assigned permissions.

In an alternative example, the notification 1102 includes credentials associated with devices to which the added user was granted access. For example, if the user was given access to a lock and a Wi-Fi network, the notification 1102 may include a passcode for the lock and a password for the Wi-Fi network.

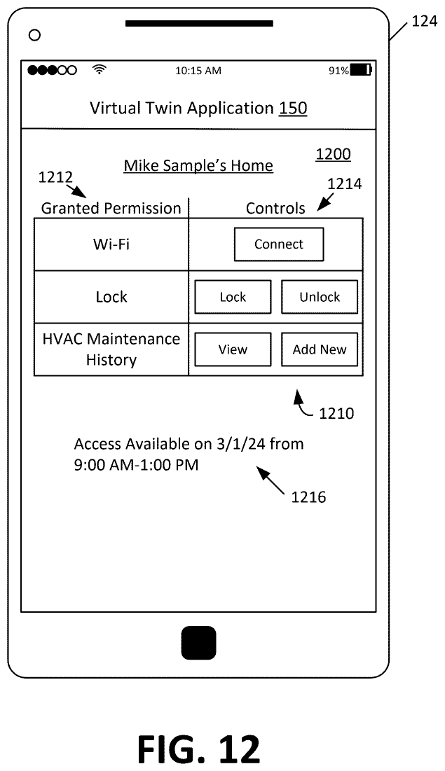

FIG. 12 illustrates an example of a limited control user interface 1200 for an added user with limited permissions. Continuing the example described above in connection with FIG. 10, a user—e.g., a repairman—may be granted permissions to access a Wi-Fi network, lock and unlock a smart lock, and view and edit an HVAC maintenance history. In embodiments, the limited control user interface 1200 includes a list 1210 of the granted permissions 1212 and controls 1214 based on the granted permissions 1212. The limited control user interface 1200 may also include a time frame 1216 during which access is available. In the illustrated example, each of the granted permissions 1212 had the same time frame (as shown in FIG. 10), so a single time frame 1216 is displayed in the limited control user interface 1200 that applies to each of the granted permissions 1212. In some embodiments, such as those in which the granted permissions 1212 have different time periods for which they are granted, the list 1210 may include a time frame 1216 for each granted permission 1212.

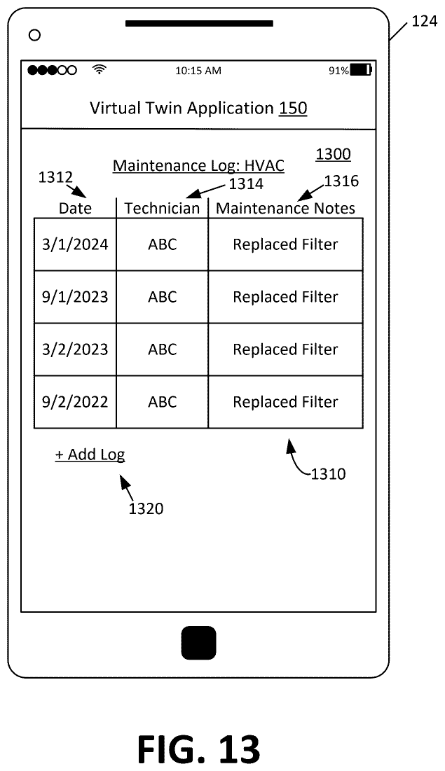

FIG. 13 illustrates an example maintenance history user interface 1300. The illustrated example includes a maintenance log 1310 for a HVAC system. Similar maintenance history user interfaces 1300 may be used for different appliances. In the illustrated embodiment, the maintenance log 1310 includes maintenance dates 1312, a name of the repair person 1314, and notes 1316 from the maintenance. In alternative embodiments, additional or alternative information may be included in the maintenance log 1310. The maintenance history user interface 1300 further includes an option 1320 to add additional entries to the maintenance log 1310. As described above, the maintenance log 1310 may be maintained within the virtual twin as dwelling information.

In examples, the maintenance history user interface 1300 may be shown to a guest user, such as a repairman, to whom a permission is granted to view or edit the maintenance log for an appliance or a device. In other examples, an owner of a virtual twin may also be able to access the maintenance history user interface 1300.

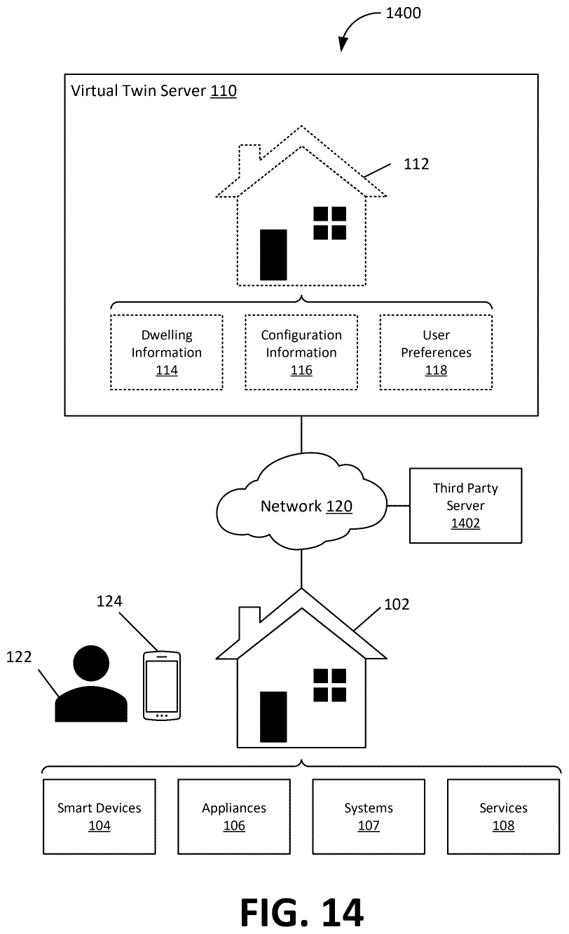

FIG. 14 illustrates an alternative embodiment of an environment 1400 for use of a virtual twin of a smart dwelling. The environment 1400 is similar to the environment described above in conjunction with FIG. 1 and includes a smart dwelling 102 connected to a virtual twin server 110 maintaining a virtual twin 112 of the smart dwelling 102.

In the illustrated embodiment, the environment 1400 further includes a third-party server 1402 connected to the virtual twin server 110 and the smart dwelling 102 over the network 120. In an example, the third-party server 1402 may provide information to the virtual twin 112 which is used to control smart devices 104 in the smart dwelling 102.

For example, the third-party server 1402 may be associated with a ride-sharing application that is registered with the virtual twin 112. In this example, the virtual twin 112 may be configured to flash a smart lightbulb on and off when the virtual twin 112 receives an indication from the third-party server 1402 that a driver of the ride-sharing service has arrived at the smart dwelling 102.

In an alternative embodiment, the virtual twin server 110 may be connected to a third-party application installed on the user's mobile device 124 in addition to or alternative to the third-party server 1402. In this embodiment, the third-party application may communicate with the virtual twin server 110 to control smart devices 104 in the smart dwelling 102 (e.g., a ride-sharing application installed on the user's mobile device 124 may send an indication that a driver has arrived at the virtual twin server 110).

In another example, the third-party server 1402 may allow users to download experiences, themes, or other customization options to change the virtual twin 112. For example, the third-party server 1402 may allow users to download other users'preferences, and the user preferences 118 in the virtual twin 112 may be changed based on the downloaded user preferences. For example, smart device settings used by other users may be downloaded and applied to the virtual twin 112.

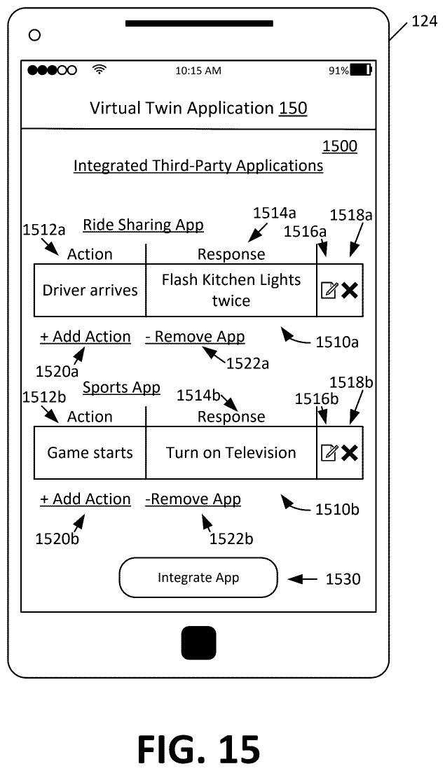

FIG. 15 illustrates an example application integration user interface 1500 for registering an application with the virtual twin. As described above, third-party applications may be integrated with the virtual twin to control aspects of the virtual twin and the smart dwelling.

In the embodiments, the application integration user interface 1500 includes integrated applications, and each integrated application is associated with a list 1510 of actions configured to affect the virtual twin or the smart dwelling. In an embodiment, the list 1510 includes actions 1512, responses 1514 to the actions 1512, and options 1516, 1518 to edit and delete the action 1512 and response 1514. Each integrated application additionally has an option 1520 to add an action 1512 to the list 1510 and an option 1522 to remove the application. The application integration user interface 1500 additionally includes an option 1530 to integrate a new application.

The illustrated embodiment includes two integrated applications 1502: a ride sharing application and a sports application, each of which are associated with an action 1512. In this embodiment, the ride sharing application is integrated with the virtual twin so that when a driver arrives at the smart dwelling to pick up the user (action 1512a), the virtual twin causes the kitchen lights in the smart dwelling to flash twice (response 1514a). The sports application is integrated with the virtual twin so that when a game starts (action 1512b), the virtual twin causes the television to turn on (response 1514b).

While the illustrated example shows responses 1514 that affect a smart dwelling, in alternative examples, the responses 1514 may affect the virtual twin. For example, a homestay application may be configured to assign permissions (e.g., smart lock access) to a guest after the guest books a short-term rental of the smart dwelling.

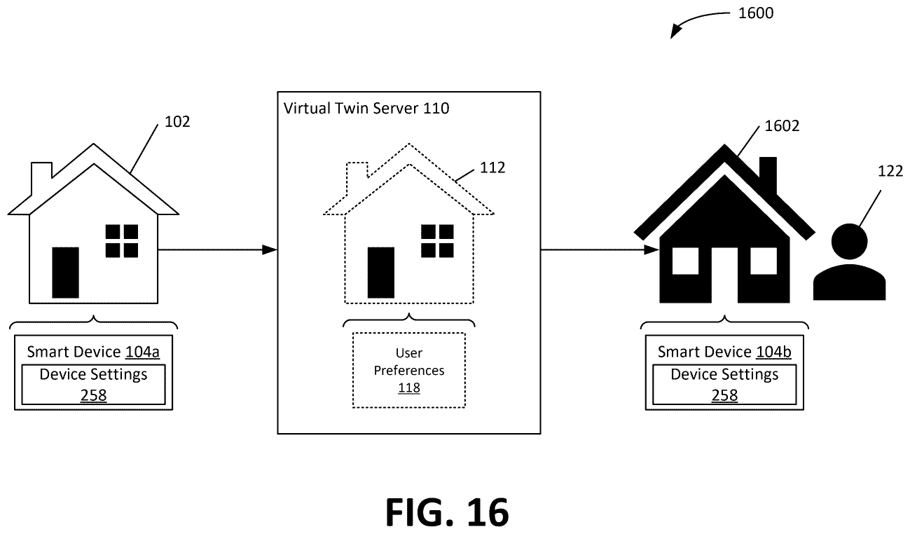

FIG. 16 illustrates a further environment 1600 in which a virtual twin of a smart dwelling is used. In the illustrated embodiment, two smart dwellings 102, 1602 are connected to the virtual twin server 110. In an example, the smart dwelling 102 is owned by a user 122, and the second smart dwelling 1602 may be a temporary dwelling, such as a short-term rental home or a hotel room. Using the virtual twin 112, the user 122 may change aspects of the temporary smart dwelling 1602 to be similar to the owned smart dwelling 102.

In the illustrated example, the owned smart dwelling 102 includes a smart device 104a for which the user 122 has defined device settings 258. For example, the smart device 104a may be a smart faucet, and the device settings 258 may define a preferred water temperature. As described herein, the user 122 may create a virtual twin 112 of the owned smart dwelling 102 that includes user preferences 118, such as the device settings 258. In addition to using the virtual twin 112 to control and manage aspects of the owned smart dwelling 102, the user 122 may also use the virtual twin 112 to align aspects of the temporary smart dwelling 1602 to the owned smart dwelling 102.

In the illustrated embodiment, the temporary smart dwelling 1602 includes a smart device 104b, which may be the same type of device as the smart device 104a in the owned smart dwelling 102 (e.g., the smart device 104b may also be a faucet). The user 122 may use the virtual twin 112 to apply the user preferences 118 set from the owned smart dwelling 102 to the temporary smart dwelling 1602. In this example, the user 122 may apply the device settings 258 that are used for the smart device 104a to the smart device 104b so that the user 122 has a similar experience with the smart device 104b as they would have with the smart device 104a (e.g., the preferred temperature set for the smart device 104a may be applied to the smart device 104b).

In an embodiment, the temporary smart dwelling 1602 may be associated with a virtual twin for which the user 122 is given at least partial control. In this embodiment, to apply the device settings 258 to the smart device 104b, the device settings 258 may be applied to the virtual twin associated with the temporary smart dwelling 1602, and the virtual twin associated with the temporary smart dwelling 1602 may apply the device settings 258 to the smart device 104b.

In embodiments, when the user 122 leaves the temporary smart dwelling 1602 (e.g., the user 122 checks-out of the short-term rental home), the virtual twin 112 may delete the device settings 258 from the smart device 104b. Removing the user preferences 118 and any associated user data that were applied to the temporary smart dwelling 1602 may improve security for the user 122 as future guests at the temporary smart dwelling 1602 will be unable to access the user preferences 118 that were applied to the temporary smart dwelling 1602.

Although this example describes applying smart device settings 258 used at an owned smart dwelling to a temporary smart dwelling 1602, in other examples, other user preferences 118 may be applied to the temporary smart dwelling 1602. For example, account credentials may be used to automatically sign-in to accounts at the temporary smart dwelling 1602. Additionally, while the example shows applying device settings 258 used for a single smart device 104a in the owned smart dwelling 102 to a single smart device 104b in the temporary smart dwelling 1602, in alternative examples, multiple user preferences 118 may be applied from the virtual twin 112 to the temporary smart dwelling 1602.

Further, while the second smart dwelling 1602 is described as a temporary smart dwelling, such as a short-term rental home, in other examples, the second smart dwelling 1602 may be any smart dwelling. Similarly, the first smart dwelling 102 is described as an owned smart dwelling, but in other examples, the first smart dwelling 102 may be any smart dwelling associated with the virtual twin 112. In an example, the user 122 may be moving from the first smart dwelling 102 to the second smart dwelling 1602. In this example, the second smart dwelling 1602 is an owned smart dwelling, and the first smart dwelling 102 is a former smart dwelling.

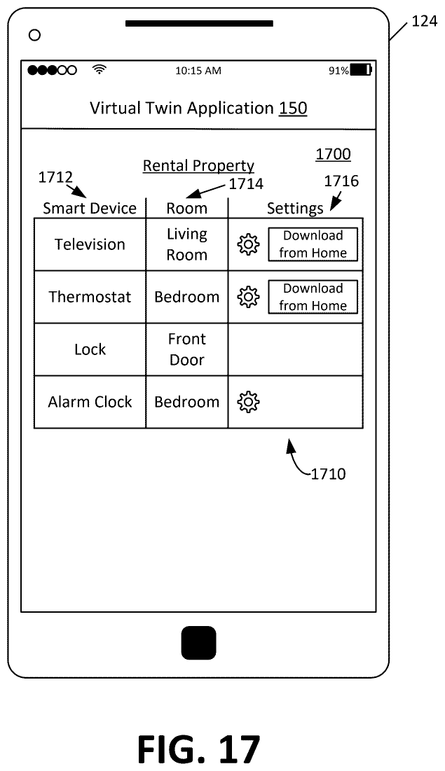

FIG. 17 illustrates an example guest home user interface 1700. In embodiments, the guest home user interface 1700 is similar to the device list user interface 300 described above in conjunction with FIG. 3, but the guest home user interface 1700 may be presented for a user visiting a temporary smart dwelling (e.g., a hotel room or a short-term rental home). Accordingly, the guest home user interface 1700 may present fewer controls than the device list user interface 300 as the user may have fewer permissions in the temporary smart dwelling as they have in his own smart dwelling.

Similar to the device list user interface 300, the guest home user interface 1700 includes a list 1710 of smart devices in the temporary smart dwelling. In embodiments, the list 1710 includes names 1712 of devices and locations 1714 of the devices. The names 1712 and locations 1714 are substantially similar to the names 312 and locations 314 described above in conjunction with FIG. 3. However, unlike the locations 314, the locations 1714 do not include an option to edit the location. As described above, the guest home user interface 1700 is presented to a user in a temporary smart dwelling, so the user may have fewer permissions than they would in an owned smart dwelling and may not have permission to edit the locations 1714.

Additionally, the list 1710 includes settings options 1716. The settings options 1716 are similar to the options 1016 described above in connection with FIG. 10; however, each device in the list 1710 may not have a settings option 1716. For example, in the illustrated embodiment, the list 1710 includes a smart lock for which a settings option 1716 is not available; the user may not have been granted permissions to change settings of the smart lock (e.g., the user cannot change the passcode of the smart lock).

Further, the settings options 1716 for some devices may include an option to download settings from another virtual twin. In some embodiments, if the user has a similar device at the owned smart dwelling as are at the temporary dwelling, the user may have the option to apply the same settings as the user uses on devices at the owned smart dwelling to the devices at the temporary smart dwelling. In the illustrated example, the user has a television and thermostat at the owned smart dwelling (as shown in FIG. 10), so the guest home user interface 1700 includes download options for the television and the thermostat. The user may use the download options to apply the settings used for the television and the thermostat at the owned smart dwelling to the television and the thermostat at the temporary smart dwelling. In an example, all settings applied to the television and the thermostat at the owned smart dwelling are applied to the television and the thermostat at the temporary smart dwelling. In another example, the user may select which settings are applied.

While the user has a lock at the owned smart dwelling, the lock at the temporary dwelling does not have a download option because the user does not have permissions to change settings of the lock at the temporary dwelling, as described above. Additionally, the alarm clock does not have a download option because the user does not have an alarm clock at the owned smart dwelling; however, the user may still use other settings options 1716 to change the settings of the alarm clock.

In some examples, downloading the settings used for a smart device may additionally retrieve account credentials associated with the smart device and log in to the corresponding smart device in the temporary smart dwelling. For example, the user may be logged in to a streaming service on the television at his smart dwelling, so downloading the television settings through the virtual twin may additionally cause the television in the temporary smart dwelling to log in to the streaming service using the account credentials registered with the virtual twin.

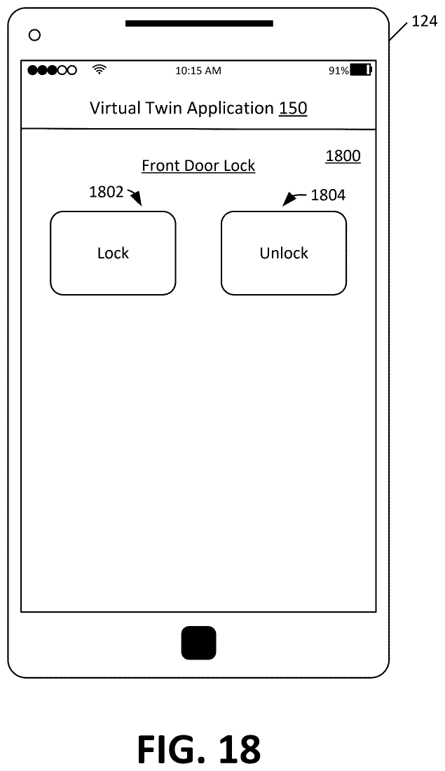

FIG. 18 illustrates an example control user interface 1800 for controlling a smart device at a temporary smart dwelling. In an example, a guest user may access the control user interface 1800 from the guest home user interface 1700 described above by selecting a name 1712 of a device in the device list 1710.

In the illustrated example, the control user interface 1800 includes controls for a smart lock. Continuing the example from above in conjunction with FIG. 17, the user may have permissions to use the smart lock but may not have permissions to change settings of the smart lock. Accordingly, in contrast to the settings user interface 400 described above in conjunction with FIG. 4, the control user interface 1800 includes buttons 1802, 1804 that allow the user to lock and unlock the smart lock, but the control user interface 1800 does not include any options to change settings of the smart lock.

In alternative examples, the user may have permissions to change some, but not all, of the settings, so the control user interface 1800 may include settings for which the user has permission to edit. Further, in examples in which the user has permissions to change all of the settings of the smart device, the control user interface 1800 may include all changeable settings of the smart device.

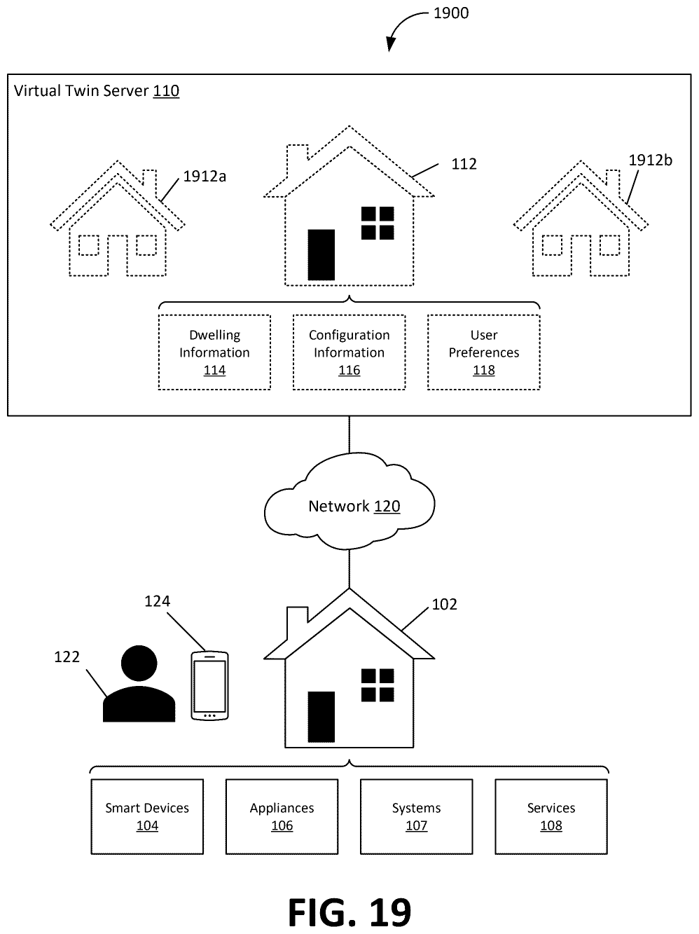

FIG. 19 illustrates a further embodiment of an example environment 1900 for use of a virtual twin. In embodiments, the virtual twin 112 may be configured to generate recommendations for a user 122 based on data in the virtual twin 112. In some embodiments, the virtual twin 112 may additionally or alternatively be configured to use data from one or more other virtual twins 1912a-b when generating recommendations for the user 122. As described further herein, the recommendations may be presented to the user 122 through a virtual twin application on a computing device 124. Additionally or alternatively, notifications with the generated recommendations may be sent to the user 122 through the computing device 124.

As described above, the virtual twin 112 may include data about a smart dwelling 102, including dwelling information 114, configuration information 116, and user preferences 118. By analyzing this information, the virtual twin 112 may determine strategies for better managing the smart dwelling 102 and associated smart devices 104, appliances 106, systems 107, and services 108. For example, the virtual twin 112 may generate recommendations to adjust settings of smart devices 104, purchase new appliances 106, and update service providers of services 108. In embodiments, an application running on the virtual twin 112 may perform the analysis and recommendation process.

Examples of recommendations are described further herein; however, the virtual twin 112 is not limited to these example recommendations. The virtual twin 112 may generate recommendations related to any aspect of the smart dwelling 102 and associated smart devices 104, appliances 106, systems 107, and services 108.

In a first example, the virtual twin 112 may recommend replacement appliances 106. For example, the virtual twin 112 may analyze the dwelling information 114 to determine that a hot water heater was installed 25 years ago and is due for replacement. Additionally or alternatively, the virtual twin 112 may analyze the dwelling information 114 to determine that the hot water heater is undersized for the number of bathrooms in the smart dwelling 102 and the number of users in the smart dwelling 102. In another example, the virtual twin 112 may analyze the user preferences 118 to determine that the hot water heater does not satisfy user priorities of energy efficiency. Based on one or more of these determinations, the virtual twin 112 may generate a recommendation to replace the hot water heater.

In addition to recommending that the hot water heater be replaced, the virtual twin 112 may also recommend potential replacements. In embodiments, the suggested replacements may be based on the dwelling information 114, configuration information 116, and user preferences 118. For example, the virtual twin 112 may recommend hot water heaters that are designed for the number of bathrooms in the smart dwelling 102 and the number of users in the smart dwelling 102. Similarly, the virtual twin 112 may recommend hot water heaters that satisfy user priorities, such as energy efficiency.

While this example describes recommendations for a hot water heater, the virtual twin may similarly generate recommendations for other appliances 106 in the smart dwelling. Similarly, the virtual twin 112 may generate recommendations for smart devices 104 and systems 107 in the smart dwelling 102.

In a second example, the virtual twin 112 may recommend new smart devices 104, appliances 106, systems 107, and services 108. For example, the virtual twin 112 may determine that the user 122 does not have a smart thermostat in the smart dwelling 102 and that the user 122 prioritizes energy savings. Accordingly, the virtual twin 112 may recommend a smart thermostat to the user 122. As described above, the virtual twin 112 may personalize the recommendation by analyzing the data in the virtual twin 112 to recommend smart thermostats that are relevant to the user (e.g., smart thermostats that satisfy user priorities).

In a third example, the virtual twin 112 may use sensor data from smart devices 104 or other devices in the smart dwelling 102 to generate recommendations for new smart devices 104, appliances 106, and systems 107. For example, the virtual twin 112 may determine that air quality is low in a kitchen based on sensor data from a smart device 104 in the kitchen. Based on this determination, the virtual twin 112 may generate a recommendation for the user 122 to purchase a range hood. The virtual twin 112 may use the dwelling information 114, configuration information 116, and user preferences 118 to generate personalized recommendations for range hoods. For example, the virtual twin 112 may generate a recommendation based on a size of the kitchen and user priorities.

In some examples, the virtual twin 112 may recommend multiple ways to improve the air quality in the kitchen. For example, in addition to the range hood, the virtual twin 112 may additionally recommend an air purifier. As with the range hood, the virtual twin 112 may analyze data to personalize the recommendations.

In a fourth example, the virtual twin 112 may recommend adjustments to device settings based on data in the virtual twin 112. For example, the virtual twin 112 may determine that the user 122 prioritizes energy savings, but several smart devices 104, appliances 106, and systems 107 are not configured with energy efficient settings. Based on this determination, the virtual twin 112 may recommend settings for these smart devices 104, appliances 106, and systems 107 to align with the priorities of the user 122. In some embodiments, the virtual twin 112 may automatically apply the recommended settings to the appropriate smart devices 104, appliances 106, and systems 107.

In a fifth example, the virtual twin 112 may analyze data from one or more other virtual twins 1912a-b to generate recommendations. In embodiments, the other virtual twins 1912a-b that are analyzed are selected based on similarities with the virtual twin 112. For example, other virtual twins 1912a-b may be associated with smart dwellings of similar sizes to the smart dwelling 102. In another example, the other virtual twins 1912a-b may be associated with smart dwellings 102 located in proximity to the smart dwelling 102 (e.g., within the same neighborhood or within the same city).

In an example, the virtual twin 112 may analyze data from the other virtual twins 1912a-b which belong to neighbors of the user 122 and determine that the neighbors are using a different trash service than the user 122. Accordingly, the virtual twin 112 may recommend that the user 122 switch to the other trash service. In addition to recommending services 108 based on other virtual twins 1912a-b, the virtual twin 112 may similarly recommend smart devices 104, appliances 106, and systems 107 based on other virtual twins 1912a-b.

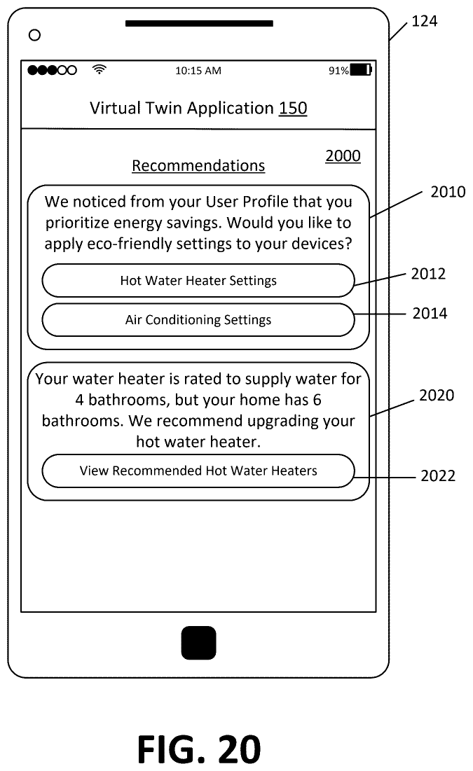

FIG. 20 illustrates an example recommendation user interface 2000 in a virtual twin application 150. In the illustrated embodiment, the recommendation user interface 200 includes recommendations 2010, 2020 generated by a virtual twin. In this example, a first recommendation 2010 recommends changing settings on devices to be more environmentally friendly. The first recommendation 2010 further includes options 2012, 2014 to change settings of corresponding devices, appliances, and systems (i.e., a hot water heater and an air conditioner). A second recommendation 2020 recommends upgrading a hot water heater. The second recommendation 2020 includes an option 2022 to view suggested hot water heaters. As described above, the virtual twin may select which hot water heaters are recommended based on data in the virtual twin (e.g., user priorities and a number of bathrooms in a smart dwelling).

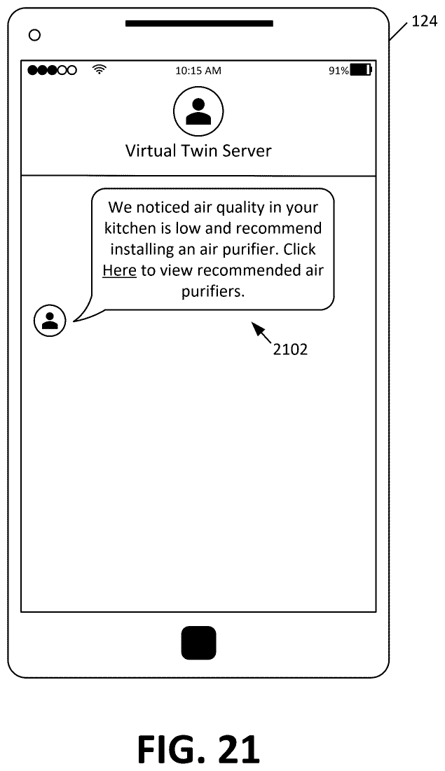

FIG. 21 illustrates an example notification 2102 transmitted to a user. In an embodiment, the notification 2102 is a text message (e.g., an SMS message) describing a recommendation generated by a virtual twin. In this example, the notification 2102 includes a recommendation that the user install an air purifier in the smart dwelling. The notification also includes a link to view recommended air purifiers. As described above, the recommendation and suggested air purifiers may be based on data in a virtual twin associated with the smart dwelling.

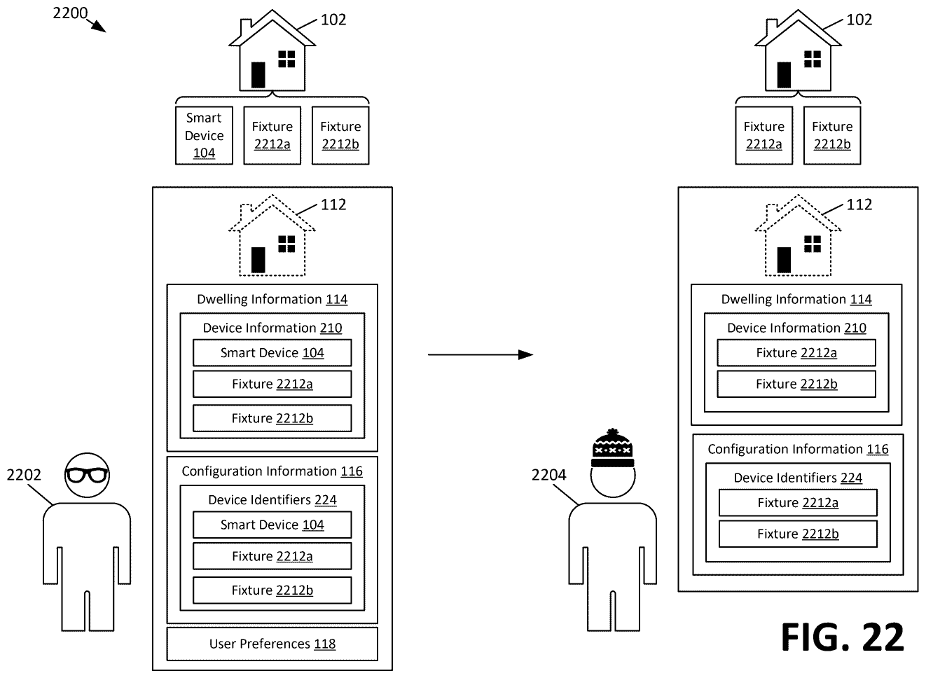

Turning to FIG. 22, an example environment 2200 for transferring ownership of a virtual twin is shown. In an example, ownership of a virtual twin 112 may transfer during a transfer of ownership of an associated smart dwelling 102. When the virtual twin 112 transfers from the seller 2202 to the buyer 2204, information included in the virtual twin 112 may be maintained through the transfer. In embodiments, some of the information included in the virtual twin 112 may be deleted before or during the transfer of the virtual twin 112 to the buyer 2204.

As described above, in embodiments, the virtual twin 112 includes dwelling information 114, configuration information 116, and user preferences 118. In the illustrated example, when the virtual twin 112 is transferred from the seller 2202 to the buyer 2204, much of the dwelling information 114 and configuration information 116 may be included with the transfer while user preferences 118 may be deleted before or during the transfer. For example, as explained above, the dwelling information 114 may include blueprints, floorplans, dimensions, appliance information, smart device information, maintenance and repair histories, device certificates, a virtual twin certificate, and ownership records; because this information may be is substantially fixed (i.e., the information does not change when the owner of the smart dwelling 102 changes), the dwelling information 114 may be preserved when the virtual twin 112 transfers from the seller 2202 to the buyer 2204. Similarly, the configuration information 116 includes a global configuration of the virtual twin 112 that is not specific to a user (such as the seller 2202). Accordingly, configuration information 116 may be maintained during the transfer of ownership.

Because the user preferences 118 may be defined by the owner of the virtual twin 112 (i.e., the seller 2202), the user preferences 118 may not carry over when the owner of the virtual twin 112 changes. In embodiments, the user preferences 118 are restored to default settings before or during the transfer.

The information in the virtual twin 112 that is maintained through the transfer process may be based on the smart devices and appliances that are identified as fixtures of the smart dwelling (i.e., the smart devices and appliances that will be transferred to the buyer 2204 with the transfer of the smart dwelling 102). In embodiments, information associated with the fixtures may be maintained. For example, device settings associated with the fixtures may be maintained, even though device settings may be included with user preferences 118. Alternatively, device settings for fixtures may be reset to factory defaults.

Similarly, while much of the dwelling information 114 and configuration information 116 may be maintained during the transfer, some of the information may be deleted. For example, smart device information 210 and device identifiers 224 associated with smart devices 104 that are not fixtures may be deleted, while the information associated with fixtures 2212a-b is maintained.

Additionally, as described above, the virtual twin 112 may track what information maintained therein is PII or private information. During a transfer of ownership, the virtual twin 112 may delete any PII and private information. In examples, this may include dwelling information 114 and configuration information 116 that would otherwise be maintained, such as device information 210. For example, device information 210 for a smart doorbell (which may be a fixture) may include images captured by the doorbell of individuals approaching the smart dwelling 102. This information may be deleted before or during the transfer of ownership even if the smart doorbell is a fixture and other device information 210 for the doorbell is maintained.

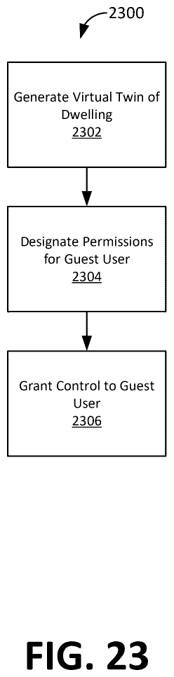

FIG. 23 illustrates a flowchart of an example method 2300 for managing access to smart devices in a smart dwelling. In the illustrated embodiment, the method 2300 includes operations 2302, 2304, 2306.

The operation 2302 includes generating a virtual twin of the smart dwelling. In an example, the virtual twin includes information associated with the smart dwelling. For example, the virtual twin may include dwelling information, configuration information, and user preferences. In embodiments, the virtual twin is generated by compiling the information associated with the virtual twin. For example, a user may enter the dwelling information, configuration information, and user preferences. In another example, at least some of the information maintained in the virtual twin may be automatically retrieved from smart devices in the smart dwelling.

The virtual twin may be used to control one or more smart devices in the smart dwelling. As described above, the virtual twin may be used to operate smart devices in the smart dwelling. Similarly, the virtual twin may be used to change settings of the smart devices in the smart dwelling.

In an embodiment, the virtual twin is generated on a virtual twin server. The virtual twin server may be connected to the smart dwelling via a network.

The operation 2304 includes designating permissions for a guest user. In examples, the permissions may determine a level of control that the guest user has over one or more smart devices in the smart dwelling. In an example, the permissions may define that the guest user can control a smart device but cannot change the settings of the smart device. For example, the permissions may designate that the guest user can lock and unlock a smart lock, but the guest user cannot change a passcode of the smart lock.

Additionally, in some embodiments, the permissions may include temporal restrictions. For example, the permissions may be associated with time periods during which the permissions are active. In an example, when the guest user is a repair person, the permissions for the repair person may be associated with a temporal restriction such that the repair person only has the permissions during a scheduled repair time.

In an embodiment, an owner of the smart dwelling and the virtual twin may designate the permissions for the guest user. For example, the owner may use a virtual twin application to assign permissions to the guest user, as described above.

The operation 2306 includes granting at least partial control of the virtual twin to the guest user. In examples, the at least partial control of the virtual twin is based on the permissions designated during the operation 2304. With the at least partial control of the virtual twin, the guest user may control designated smart devices in the smart dwelling. In another example, the guest user may use the at least partial control to update information in the virtual twin. For example, the guest user may update a maintenance and repair history for an appliance in the virtual twin.

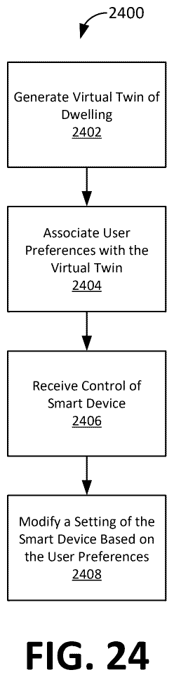

FIG. 24 illustrates a flowchart of an example method 2400 for managing settings of smart devices. In the illustrated example, the method 2400 includes operations 2402, 2404, 2406, 2408.

The operation 2402 includes generating a virtual twin of a first smart dwelling. As described above, the virtual twin may include dwelling information, configuration information, and user preferences. In embodiments, the user preferences include settings for smart devices in the first smart dwelling.

In examples, the information in the virtual twin is input by a user. The virtual twin may be used to control smart devices in the first smart dwelling. In an embodiment, the virtual twin is generated on a virtual twin server. The virtual twin server may be connected to the smart dwelling via a network.

The operation 2404 includes associating one or more user preferences with the virtual twin. In an embodiment, the associated user preferences include one or more smart device settings. In an example, the user preferences may be associated with the virtual twin when the virtual twin is generated. For example, a user may input the user preferences. In another example, the virtual twin may automatically pull user preferences from the smart devices in the first smart dwelling when the virtual twin is generated.

In alternative embodiments, the user preferences are associated with the virtual twin after the virtual twin is generated. For example, a user may update settings of smart devices in the first smart dwelling. Similarly, the user may add a new smart device to the virtual twin and add device settings for the new smart device.

In an embodiment, a user may use a virtual twin application to associate user preferences with the virtual twin. For example, the user may use the virtual twin application to modify settings of a smart device in the first smart dwelling.

The operation 2406 includes receiving at least partial control of a smart device in a second smart dwelling. For example, the second smart dwelling may be a short-term rental property, and the at least partial control of the smart device may be received for a time period during which the short-term rental property is rented.

In an embodiment, the at least partial control of the smart device includes permissions to change settings of the smart device. In an example, the at least partial control of the smart device may be received by permissions being granted in a virtual twin associated with the second smart dwelling.

The operation 2408 includes modifying a setting of the smart device based on the user preferences associated with the virtual twin of the first smart dwelling. In an embodiment, the setting is automatically modified. For example, the setting of the smart device may be modified to align with a corresponding setting of a smart device in the first smart dwelling.

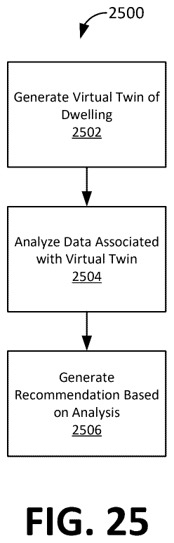

FIG. 25 illustrates a flowchart of an example method 2500 for generating recommendations using a virtual twin. In the illustrated embodiment, the method 2500 includes operations 2502, 2504, 2506.

The operation 2502 includes generating a virtual twin of a dwelling. As described above, the virtual twin may include dwelling information, configuration information, and user preferences. In embodiments, the user preferences include settings for smart devices in the first smart dwelling.

In examples, the information in the virtual twin is input by a user. The virtual twin may be used to control smart devices in the first smart dwelling. In an embodiment, the virtual twin is generated on a virtual twin server. The virtual twin server may be connected to the smart dwelling via a network.

The operation 2504 includes analyzing data associated with the virtual twin. In an example, dwelling information, configuration information, and user preferences are analyzed. For example, the analysis may determine that a hot water heater was installed 25 years ago and is sized to provide water to three bathrooms. The analysis may also determine that a smart dwelling associated with the virtual twin has six bathrooms. In an embodiment, an application running on the virtual twin performs the analysis.

The operation 2506 includes generating recommendations based on the analysis. Continuing the example from above, a recommendation may include a recommendation to replace a hot water heater based on an age of the current hot water heater and the current hot water heater not being large enough for the number of bathrooms in the smart dwelling. In an embodiment, the recommendation may further include suggested replacement hot water heaters. The suggested replacement hot water heaters may be determined based on an analysis of data in the virtual twin (e.g., the number of bathrooms in the smart dwelling and user priorities). In an embodiment, an application operating on the virtual twin generates the recommendation.

Although examples described above relate to recommendations to replace a hot water heater, in alternative examples, recommendations may be generated related to any aspect of a smart dwelling or associated smart devices, appliances, systems, and services.

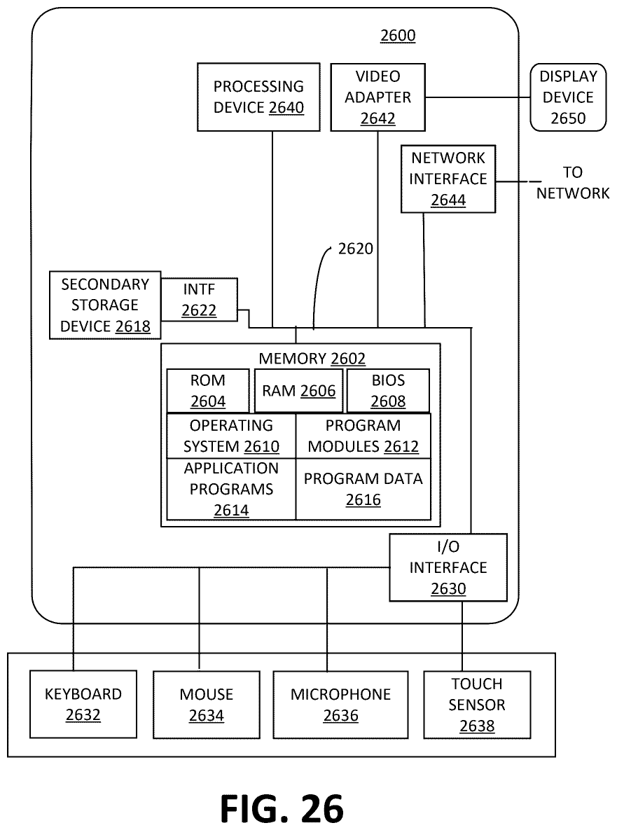

FIG. 26 illustrates an exemplary architecture of a computing device 2600 which can be used to implement aspects of the present disclosure, including the user mobile device 124 and the virtual twin server 110. The computing device 2600 is used to execute functions described herein.

The memory 2602 includes read only memory 2604 and random-access memory 2606. A basic input/output system 2608 containing the basic routines that act to transfer information within computing device 2600, such as during start up, is typically stored in the read only memory 2604.

The computing device 2600 also includes a secondary storage device 2618 in some embodiments, such as a hard disk drive, for storing digital data. The secondary storage device 2618 is connected to the system bus 2620 by a secondary storage interface 2622. The secondary storage devices 2618 and their associated computer readable media provide nonvolatile storage of computer readable instructions (including application programs and program modules), data structures, and other data for the computing device 2600.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 2618 or memory 2602, including an operating system 2610, one or more application programs 2614, other program modules 2612, and program data 2616. The computing device 2600 can utilize any suitable operating system.

In some embodiments, a user provides input to the computing device 2600 through one or more input devices. Examples of input devices include a keyboard 2632, mouse 2634, microphone 2636, and touch sensor 2638 (such as a touchpad or touch sensitive display). Other embodiments include other input devices. The input devices are often connected to the processing device 2640 through an input/output interface 2630 that is coupled to the system bus 2620. These input devices can be connected by any number of input/output interfaces, such as a parallel port, serial port, game port, or a universal serial bus. Wireless communication between input devices and the interface is possible as well, and includes infrared, Bluetooth® wireless technology, 802.11a/b/g/n, cellular, or other radio frequency communication systems in some possible embodiments.

In this example embodiment, a display device 2650, such as a monitor, liquid crystal display device, projector, or touch sensitive display device, is also connected to the system bus 2620 via an interface, such as a video adapter 2642. In addition to the display device 2650, the computing device 2600 can include various other peripheral devices (not shown), such as speakers or a printer.

When used in a local area networking environment or a wide area networking environment (such as the Internet), the computing device 2600 is typically connected to the network through a network interface 2644, such as an Ethernet interface. Other possible embodiments use other communication devices. For example, some embodiments of the computing device 2600 include a modem for communicating across the network.

The computing device 2600 typically includes at least some form of computer readable media. Computer readable media includes any available media that can be accessed by the computing device 2600. By way of example, computer readable media includes computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 2600.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

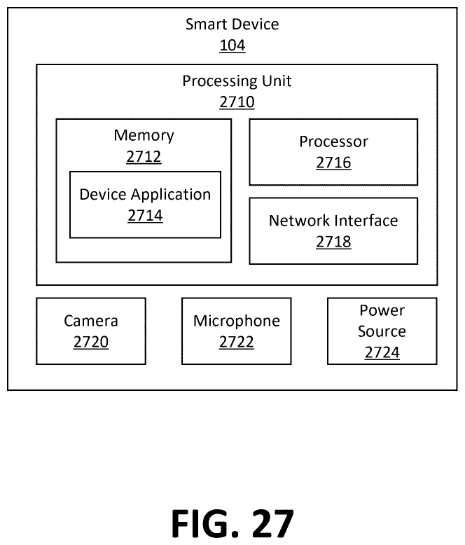

FIG. 27 illustrates an example smart device 104. The smart device includes a processing unit 2710, a camera 2220, a microphone 2722, and a power source 2724. The processing unit 2710 includes a memory 2712, a processor 2716, and a network interface 2718. The memory 2712 includes a device application 2714.

The smart device includes the processing unit 2710. The processing unit 2710 operates to control the smart device, process video data, and communicate with other devices via a network.

The processing unit includes a memory 2712, a processor 2716, and a network interface 2718. Examples of the memory 2712, processor 2716, and network interface 2718 are illustrated and described in reference to FIG. 26.

The memory 2712 includes a device application 2714. The device application 2714 operates the various functions of the smart device 104. In an example, if the smart device 104 is a smart camera device, the device application 2714 may include instructions for when video should be recorded, when different components of the smart camera should be activated (e.g., turning on the camera 2220 or the microphone 2222), providing battery status updates, initiating automations, etc.

The camera 2720 is a digital camera which contains sensors to detect light which is processed and stored as recorded images, series of images, or video (series of images or frames).

The microphone 2722 operates to record audio in conjunction with the camera 2720 recording video. In some embodiments, the smart device 104 does not include a microphone 2722.

The power source 2724 powers the smart device 104. In some embodiments, the power source 2724 is one or more batteries. In other examples, the smart device includes an AC power plug or other electrical connection. Other power sources can also be used.

In alternative embodiments, the smart device 104 may include additional or alternative components and may not include some of the components described herein, depending on the function of the smart device 104. For example, a smart television may include a display but may not include the camera 2720.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A method for managing access to a smart device, the method comprising:
generating a virtual twin of a dwelling, wherein the virtual twin of the dwelling includes control of one or more smart devices in the dwelling;
designating one or more permissions for a guest, the one or more permissions including a level of control of the one or more smart devices in the dwelling; and
granting at least partial control of the virtual twin of the dwelling to the guest, wherein the at least partial control of the virtual twin of the dwelling is based on the designated one or more permissions.

2. The method of claim 1, wherein the at least partial control of the virtual twin of the dwelling includes a temporal restriction, wherein the guest has at least partial control of the virtual twin of the dwelling during a time period designated by the temporal restriction.

3. The method of claim 1, further comprising:
automatically modifying a setting of at least one of the one or more smart devices in the dwelling for which the guest has at least partial control based on preferences of the guest.

4. The method of claim 3, wherein the one or more preferences of the guest include preferences associated with a virtual twin of a second dwelling.

5. The method of claim 1, wherein the virtual twin of the dwelling includes dwelling information associated with the dwelling, configuration information, and user preferences.

6. The method of claim 5, wherein the dwelling information includes a floorplan of the dwelling, a certificate associated with the virtual twin, and ownership records of the virtual twin.

7. The method of claim 5, wherein the configuration information includes identifiers for one or more rooms in the dwelling, identifiers for the one or more smart devices in the dwelling, locations of the one or more smart devices in the dwelling, a list of service providers, status information for the one or more smart devices in the dwelling, and update data for the one or more smart devices in the dwelling.

8. The method of claim 5, wherein the user preferences include smart device settings, voice commands, and account credentials.

9. A method for managing a setting of a smart device, the method comprising:
generating a virtual twin of a first dwelling, wherein the virtual twin of the first dwelling includes control of one or more smart devices in the first dwelling;
associating one or more user preferences with the virtual twin of the first dwelling, the one or more user preferences including settings for at least one of the one or more smart devices;
receiving at least partial control of a smart device in a second dwelling; and
automatically modifying a setting of the smart device in the second dwelling based on the user preferences associated with the virtual twin of the first dwelling.

10. The method of claim 9, wherein receiving at least partial control of the smart device in the second dwelling includes:
receiving at least partial control of a virtual twin of the second dwelling.

11. The method of claim 9, wherein the one or more user preferences includes account credentials; and
automatically modifying the setting of the smart device in the second dwelling based on the user preferences associated with the virtual twin of the first dwelling includes:
accessing an account on the smart device using the account credentials.

12. The method of claim 9, wherein the user preferences include smart device settings, voice commands, and account credentials.

13. A method for generating a recommendation for a smart dwelling, the method comprising:
generating a virtual twin of a smart dwelling, the virtual twin including data associated with the smart dwelling;
analyzing the data in the virtual model associated with the smart dwelling; and
generating, based on the analysis, a recommendation associated with the smart dwelling.

14. The method of claim 13, further comprising:
presenting the recommendation to a user in a user interface of a virtual twin application.

15. The method of claim 13, further comprising:
transmitting, to a computing device of a user, a notification including the recommendation.

16. The method of claim 15, wherein the notification is a SMS message.

17. The method of claim 13, wherein the recommendation includes a suggested change to a setting of a smart device.

18. The method of claim 17, further comprising:
automatically changing the setting of the smart device based on the recommendation.

19. The method of claim 13, further comprising:
analyzing data in a second virtual model associated with a second smart dwelling,
wherein the recommendation is further based on the analysis of the data in the second virtual model.

20. The method of claim 13, wherein the recommendation includes a suggested device to purchase for the smart dwelling.
